(19) United States
(12) Patent Application Publication
(10) Pub. No.: US 2026/0310377 A1
(43) Pub. Date: Oct. 8, 2026

(54) SCALABLE INTERCONNECTION-NETWORK-CENTRIC MEMORY EXPANSION SYSTEMS FOR ACCELERATORS

(71) Applicant: MangoBoost, Inc., Bellevue, WA (US)

(72) Inventors: Rachata Ausavarungnirun, Skokie, IL (US); Chanik Park, Santa Clara, CA (US); James C. Hoe, Pittsburgh, PA (US); HoRang Jang, Seoul (KR)

(73) Assignee: MangoBoost, Inc., Bellevue, WA (US)

(21) Appl. No.: 19/636,020

(22) Filed: Apr. 1, 2026

Related U.S. Application Data
(60) Provisional application No. 63/783,496, filed on Apr. 4, 2025.

(51) Int. Cl. G06F 3/06

(52) U.S. Cl. CPC G06F 3/0655; G06F 3/0604; G06F 3/0685

(57) ABSTRACT

A system may include a plurality of tiers of compute nodes, a plurality of tiers of memory nodes, and one or more controllers. The plurality of tiers of compute nodes may include a first tier of compute nodes including one or more Graphics Processing Units (GPUs) and a second tier of compute nodes including one or more Central Processing Units (CPUs). The plurality of tiers of memory nodes, coupled to corresponding tiers of compute nodes and shared by the plurality of tiers of compute nodes using an interconnection network, may include a first tier of memory nodes and a second tier of memory nodes having lower bandwidth than the first tier of memory nodes. The one or more controllers may be configured to store data in one of the first tier of memory nodes or the second tier of memory nodes, based on one or more characteristics of the data.

### CROSS-REFERENCE TO RELATED APPLICATION

This application claims priority to U.S. Provisional Patent Application No. 63/783 , 496 filed on April 4 , 202 5 , which is incorporated by reference herein in its entirety for all purposes.

### FIELD OF DISCLOSURE

The present disclosure is generally related to scalable memory systems and/or methods , including but not limited to controlling a plurality of tiers of compute nodes and a plurality of tiers of memory nodes coupled to corresponding tiers of compute nodes .

### BACKGROUND

Modern artificial intelligence (AI) and/or high-performance computing (HPC) workloads (e.g., AI and/or HPC applications) may use large memory pools to store model parameters, activation states, key-value (KV) caches, knowledge source and its corresponding corpus data used in retrieval-augmented generation (RAG) for AI/ machine learning (ML) applications, series -based raw data used by scientific applications, multi-agent AI applications, and/or inference and training applications. Existing GPU architectures and AI accelerators may rely solely on HBM attached to the accelerators to store these data. Improvements to scalability of memory systems remain desired.

### SUMMARY

Various embodiments disclosed herein are related to a system. The system may include a plurality of tiers of compute nodes, a plurality of tiers of memory nodes, and one or more controllers. The plurality of tiers of compute nodes may include a first tier of compute nodes including one or more Graphics Processing Units (GPUs) and a second tier of compute nodes including one or more Central Processing Units (CPUs). The plurality of tiers of memory nodes, coupled to corresponding tiers of compute nodes and shared by the plurality of tiers of compute nodes using an interconnection network, may include a first tier of memory nodes and a second tier of memory nodes having lower bandwidth than the first tier of memory nodes. The one or more controllers may be configured to store data in one of the first tier of memory nodes or the second tier of memory nodes, based on one or more characteristics of the data.

Various embodiments disclosed herein are related to circuitry. The circuitry may control a plurality of tiers of compute nodes and a plurality of tiers of memory nodes coupled to corresponding tiers of compute nodes. The plurality of tiers of compute nodes may include a first tier of compute nodes including one or more GPUs and a second tier of compute nodes including one or more CPUs. The plurality of memory nodes may include a first tier of memory nodes and a second tier of memory nodes having lower bandwidth than the first tier of memory nodes. The circuitry may include one or more controllers configured to control the plurality of tiers of compute nodes to share the plurality of memory nodes using an interconnection network. The one or more controllers may be configured to store data in one of the first tier of memory nodes or the second tier of memory nodes, based on one or more characteristics of the data.

Various embodiments disclosed herein are related to a method for controlling a plurality of tiers of compute nodes and a plurality of tiers of memory nodes coupled to corresponding tiers of compute nodes. The plurality of tiers of compute nodes may include a first tier of compute nodes including one or more GPUs and a second tier of compute nodes including one or more CPUs. The plurality of memory nodes may include a first tier of memory nodes and a second tier of memory nodes having lower bandwidth than the first tier of memory nodes. The method may include sharing, by the plurality of tiers of compute nodes, the plurality of memory nodes using an interconnection network. The method may include storing, by one or more controllers, data in one of the first tier of memory nodes or the second tier of memory nodes, based on one or more characteristics of the data.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing.

FIG. 1 A is a diagram of an example memory system including an interconnect network.

FIG. 1 B is a diagram of an example memory system including an interconnect switch .

FIG. 2 is a diagram of an example memory system illustrating cold-start problems.

FIG. 3 A and 3B are diagrams of a multi-tier memory system, according to an example implementation of the present disclosure.

FIG. 4 is a diagram of a tier-2 memory expansion, according to an example implementation of the present disclosure.

FIG. 5 is a diagram of a tier-3 memory expansion, according to an example implementation of the present disclosure.

FIG. 6 is a diagram of a multi-tier memory system performing address translation, according to an example implementation of the present disclosure.

FIG. 7 is a diagram of a multi-tier memory system in which hot and cold application data are distributed across tiers to optimize performance , according to an example implementation of the present disclosure.

FIG. 8 is a diagram of a multi-tier memory system performing a scalable hierarchical aggregation and reduction protocol (SHARP) , according to an example implementation of the present disclosure.

FIG. 9 is a diagram of a multi-tier memory system performing a checkpointing mechanism, according to an example implementation of the present disclosure.

FIG. 10 is a diagram of a multi-tier memory system performing a quick start and resume mechanism, according to an example implementation of the present disclosure.

FIG. 11A and FIG. 11B are diagrams of a multi-tier memory system performing dual-mode operations, according to an example implementation of the present disclosure.

FIG. 12 is a diagram of data transfer between storages and a host computer, according to an example implementation of the present disclosure.

FIG. 13 is a diagram of data movement and transfer between storages and GPU clusters, according to an example implementation of the present disclosure.

FIG. 14 is a flowchart showing a process for controlling a plurality of tiers of compute nodes and a plurality of tiers of memory nodes coupled to corresponding tiers of compute nodes, according to an example implementation of the present disclosure.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

In one aspect, m odern artificial intelligence ( AI ) and /or high-performance computing (HPC) workloads (e.g., AI and/or HPC applications) may use large memory pools to store model parameters, activation states, key-value (KV) caches, knowledge source and its corresponding corpus data used in retrieval-augmented generation ( RAG ) for AI/ machine learning ( ML ) applications, series -based raw data used by scientific applications, multi-agent AI applications, and/or inference and training applications. Existing GPU architectures and AI accelerators may rely solely on high bandwidth memory (HBM) attached to the accelerators to store these data.

However, the HBM attached to accelerators and GPUs is both expensive and limited in capacity. This constraint can pose significant challenges for modern AI/ML workloads as increasingly mature and memory intensive models are deployed to serve users, particularly in applications that must scale. For example, AI agent workloads often require diverse, specialized large language models (LLMs) to support use cases ranging from internal business operations to government services involving multiple concurrent agents. Each agent may require a substantial amount of memory depending on the number of model parameters. In RAG workloads, external data may be dynamically extracted and constructed as the knowledge source for the language model. These external datasets are typically large and may span terabytes of memory. Despite the growing demand, the limited memory capacity of modern GPUs restricts the size of data available to the model. As a result, for example, even high performance systems with 8 GPUs may support no more than approximately 16 high performance LLM agents or 50 small models running across multiple agents sharing a single corpus in a RAG system, even with hardware level optimizations.

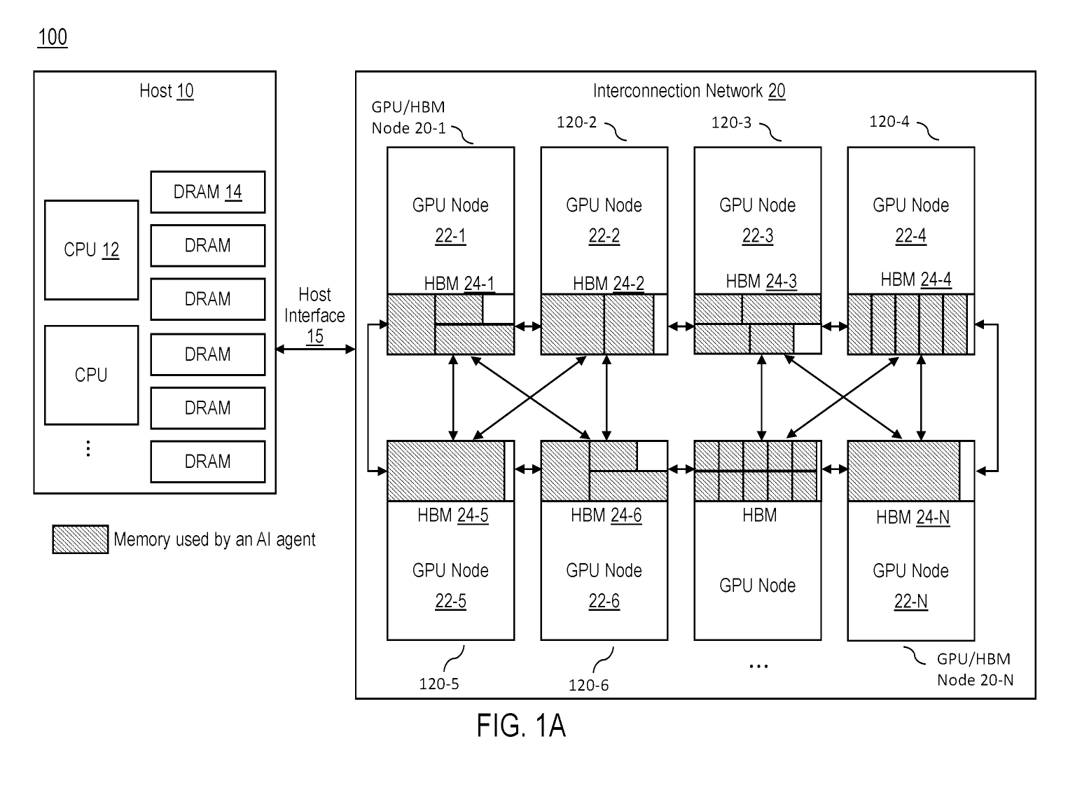

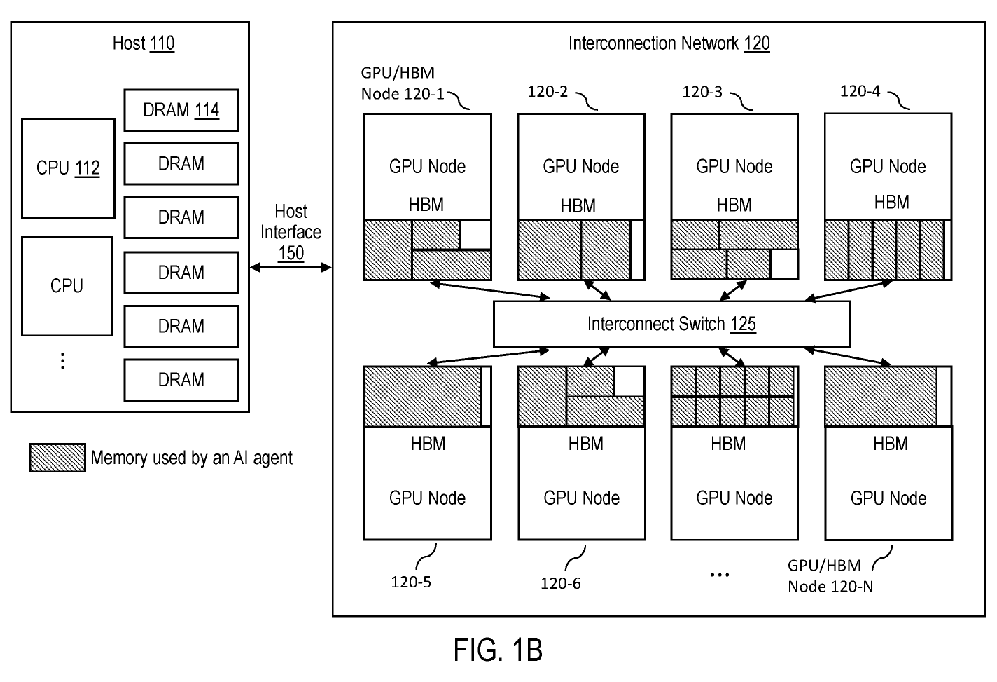

FIG. 1 A is a diagram of an example memory system 100 including an interconnect network, which is a conventional b aseline system with 8 GPUs (e.g., NVIDIA ® H100 GPUs) hosting multi-agent services with a cubemesh topology (e.g., NVIDIA ® NVLink cubemesh topology ) . In the system 100, a host 10 may include one or more central processing unit s (CPU s ) 12 coupled to Dynamic Random Access Memory (DRAM) 14 . The host 10 may be connected to a set of accelerator nodes through a host interface 15 (e.g., Peripheral Component Interconnect Express ( PCIe )) and an interconnection network 20 (e.g., NVIDIA ® NVLink interconnect) . The interconnection network 20 may include a plurality of GPU nodes 22 1, 22 2, 223, 224, 225, 226, …, 22 N are shown, each including local HBM 24 1, 242, 243, 244, 245, 246, …, 24 N. In the illustrated conventional topology, the accelerators may form part of GPU/HBM nodes 20 1 … 20 N arranged under the interconnection network 20 . An application (e.g., AI agent) can use regions of memory in local HBM at each node.

FIG. 1 B is a diagram of an example memory system 150 including an interconnect switch 125 (e.g., NVIDIA ® NVSwitch). FIG. 1B shows a conventional b aseline system with 8 GPUs (e.g., NVIDIA ® H100 GPUs) hosting multi-agent services with all-to-all connection through the interconnect switch 125 . In the system 150, a host 110 including CPUs 112 and DRAM 114 may connect , via a host interface (e.g., PCIe ) , to a GPU fabric implemented with an interconnection network 120 (e.g., NVLink interconnect ) and the interconnect switch 125 (e.g., NVSwitch ), providing all to all connectivity among multiple GPUs. As shown in FIG. 1B , a plurality of GPU/HBM nodes 120 1 … 120 N may include local HBM devices and participate in the interconnection network 120 . FIG. 1B shows that memory used by an AI agent, illustrating how agent memory is placed locally to the GPU to limit interconnect overhead, which may result in underutilization or fragmentation across the cluster when workloads are distributed.

As shown in FIGS. 1A and 1B, w hile an interconnection network (e.g., NVLink or UALink ) enables high-bandwidth GPU interconnects allowing multiple GPUs’ memory to be pooled together and used as a larger memory, the capacity may be still limited to the size of the total HBM available for each GPU with no option to expand this memory or face a prohibitively high performance degradation due to the slow data transfer between the CPU memory and the GPU memory. Because the interconnection network that operates memory access in the cache granularity is limited to either those HBM slices within the GPU memory ( see FIG. 1A), or the additional memory connected through the interconnect switch ( see FIG. 1B), the total high-performance memory pool usably by the GPUs may be limited. This limited memory capacity in GPU has become a major scaling challenge for future AI workloads even though the GPU can provide enough computing power to handle multiple agents in each node. This poses a significant challenge to many AI/ML workloads. For example, a GPU cluster might not be able to store enough multi-AI-agents’ data in its HBM to realize the throughput potential of its GPU cores. A system deploying KV-cache can face severe performance degradation when the size of KV-cache extends to the host’s memory. An AI search application might have to store terabytes of warm data and petabytes of cold data and objects while serving multiple concurrent searches. A RAG application cannot realize the full power of the GPU as it was not able to expand its data beyond what is available in the HBM or may face much higher performance degradation when it needs to access a flash storage that operates in a different granularity through a method such as NVIDIA ® GPUDirect storage.

One approach to this problem can be to add more memory (e.g., additional HBM ). However, in this case, GPU nodes are not scalable and can significantly increase the total cost of a GPU cluster. Adding more GPU nodes with HBM also does not fundamentally resolve the low GPU core utilization due to the limited memory capacity. Adding more HBM to the GPU node can also significantly increase the node’s power consumption, which leads to cost and power delivery concerns.

Another approach may involve connecting CPU cores and DRAM using technologies such as NVIDIA® NVLink chip to chip (C2C). However, this approach may also encounter scalability limitations because such systems rely on the CPU to drive all extensible memory. Moreover, when a CPU is introduced to provide GPU access to host memory over an interconnection network (e.g., an NVLink based interconnect or an UALink-based interconnect), memory requests may be routed through the CPU’s memory controller. This routing introduces additional hops before the request reaches its target location in the CPU’s DRAM, thereby increasing latency. This approach may also create programmability challenges, as programmers are typically required to manually manage data placement, memory access, and /or synchronous data transfers (e.g., using Remote Direct Memory Access (RDMA)). The interconnection network may include at least one of an NVLink based interconnect or an UALink-based interconnect.

Aside from these approaches, other methods for scaling GPU memory , e.g., Compute Express Link (CXL)–based memory expansion , may also encounter significant limitations. First, because CXL operates under a different protocol, it lacks efficient memory management mechanisms needed to seamlessly coordinate data movement between host memory and accelerator memory within a unified address space. Consequently, additional techniques are required to optimize performance, reduce memory fragmentation, minimize unnecessary data transfers across memory tiers, and provide the resiliency and persistency required for GPU computations. Second, CXL expansion does not extend coherence to NAND based devices within the memory hierarchy, thereby restricting the total usable memory to what can be provided by traditional HBM and DRAM resources.

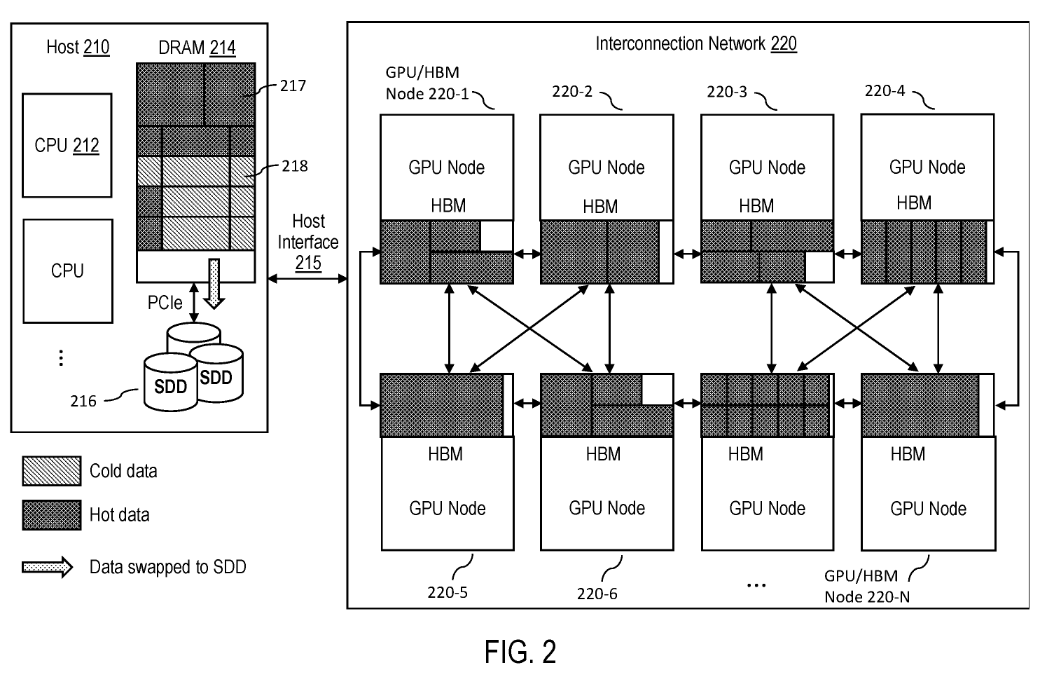

Another set of challenges facing AI applications arises when multiple AI and HPC workloads are executed in shared environments, such as cloud platforms or time sharing supercomputers. In these settings, multiple users or processes may be required to either statically partition accelerator resources , or time share the available GPUs. Under a time sharing model, AI or HPC applications may need to either checkpoint their progress, terminate active instances, and release the accelerator for another workload, or complete their entire execution before another entity can access the GPUs. Both approaches lead to inefficiencies . For example , checkpoint and yield models may incur overhead and state management complexity, while full completion models may create long queuing delays for other users requiring GPU access. This lack of efficient pause and resume capability stems from (1) insufficient memory resources to retain the execution state of all concurrently running containers or virtual machines, and /or (2) the absence of persistent storage mechanisms that guarantee paused processes can later be resumed reliably. The function as a service (FaaS) model further exacerbates these issues because functions are typically short lived and experience frequent cold start events, yet available main memory resources are insufficient to cache all active or recently invoked services, as illustrated in FIG. 2.

FIG. 2 is a diagram of an example memory system 200 illustrating time sharing in a GPU cloud environment and highlighting the importance of cold start problems. In the system 200, a host 210 including CPUs 212, DRAM 214, and solid state drive ( SSD ) storage 216 is coupled, via a host interface 215 (e.g., PCIe) and an interconnection network 220 (e.g., an NVLink interconnect), to a set of GPU/HBM nodes 220 -1 , 220 -2 , 220 -3 , 220 -4 , 220 -5 , 220 -6 , …, 220 -N (where n is a positive integer), each including local HBM. FIG. 2 depicts hot data (e.g., data that is frequently accessed or updated) and cold data (e.g., data that is infrequently accessed) within the memory hierarchy. When capacity pressure arises, portions of DRAM 214 may be swapped to SSD storage 216, indicating that host memory is periodically exchanged with slower SSD storage. In this scenario, the available memory local to the GPUs is insufficient to store all hot data used by concurrently running images or services. As a result, portions of the data stored in the host’s DRAM may occasionally be swapped to the much slower SSD storage. This swapping can cause subsequent data accesses to incur significantly longer latency than normal read or write operations, for example, when a memory access that would ordinarily be satisfied from DRAM may instead need to be serviced through demand paging from SSD storage. In such cases, read and write operations to data stored in NAND‑based SSDs are substantially slower, leading to degraded performance and increased access latency for the executing workloads.

To address these problems, the present disclosure includes systems, devices, and methods for introducing a scalable memory ( expansion ) system (also referred to as “ memory system ” ) for high-performance GPU interconnection network s (such as NVLink, Compute Express Link (CXL), or Ultra Accelerator Link (UALink)) . In some implementations, the memory system can provide advanced caching, virtual address mapping, RDMA-based direct memory access, multi-node SHARP (Scalable Hierarchical Aggregation and Reduction Protocol) for optimal multi-node communication, persistent memory layer that is backed by a NAND-based devices to further improve reliability, and /or a scalable NAND-based memory pool that further increase to total memory available to AI/ML and HPC systems.

In some implementations, the memory system can utilize scalable memory architectures for high-performance AI, ML, and /or HPC systems running on accelerators such as GPUs over a high-performance interconnection network such as NVLink, Universal Chiplet Interconnect Express ( UCIe), CXL, UALink fabric , or the like . In some implementations, the memory system may provide advanced memory management schemes such as caching, virtual address translation, error handling, high-speed interconnects, and /or multi-node memory sharing technologies to optimize multi-agent execution. In some embodiments, the term “ accelerator ” may refer to any processing element that is designed to perform computational tasks more efficiently than a general purpose processor for certain classes of workloads. An accelerator may include hardware that executes highly parallel operations, supports specialized instruction paths, or provides optimized data movement capabilities that enhance the performance of artificial intelligence, machine learning, or high performance computing tasks. For example, an accelerator may include devices such as a GPU that carries local high bandwidth memory and is capable of accessing interconnect attached memory tiers through high speed fabrics.

In some implementations, the memory system can provide a hierarchical interconnect attached memory expansion architecture for accelerators. The memory system may enable efficient multi GPU memory sharing, seamless memory management, and high bandwidth access across accelerators (e.g., GPUs ) through high performance interconnection networks such as NVLink, CXL.mem, CXL.io, UALink, chiplet based UCIe, or similar technologies that support DRAM based and/or NAND based memory expansion. In some implementations, the memory system can further include an on die cache controller that provides coherency; an aggregation and/or reduction accelerator capable of performing in DRAM aggregation and /or reduction operations; AI assisted cache and memory management policies; persistent memory support; and /or unified virtual addressing capabilities.

In some implementations, the memory system can provide a scalable, fault-tolerant, and high-bandwidth network-interconnection -based memory expansion system tailored for large-scale AI and HPC workloads. By integrating RDMA, scalable hierarchical aggregation and reduction (SHARP), multi-node and multi-tier memory pooling, application-aware caching, virtual address management, self-healing error handling mechanisms, transparent dual-mode persistent memory/storage, and /or the initiator/target capability, the memory system can enable efficient multi-agent execution, efficient execution of GPU and accelerators in the cloud, reduce memory bandwidth constraints, minimize reliance on SSD swaps, and /or allow accelerators to handle storage operations more efficiently.

In some implementations, the memory system can employ a multi tiered memory management architecture in which a first tier of memory includes HBM that serves active tensor computations on one or more GPUs (or one or more accelerators) . A second tier of memory may include DRAM attached via a network interconnect or an interconnection fabric (e.g., NVLink , UALink, PCIe, InfiniBand, or the like) to extend model storage beyond the capacity of the first tier while maintaining low latency access characteristics. A third tier of memory may include raw NAND augmented with a DRAM cache . The third tier of memory may be utilized for cold data , e.g., data including inactive models and /or services , and for persistent retention within the memory subsystem. The interconnection fabric may support remote direct memory access (RDMA) to provide direct GPU to GPU memory transactions that enable peer to peer data movement with minimal CPU involvement. Multi GPU communication may be accelerated through scalable hierarchical aggregation and reduction (SHARP), thereby reducing congestion and /or improving both distributed inference and training efficiency. In some implementations , the memory system may provide dynamic , interconnection fabric-based (e.g., NVLink based ) memory pooling to permit multiple GPUs and nodes to share remote memory resources efficiently, and may further maintain a large page cache pool backed by the second and /or third tiers so that frequently accessed files and objects can be cached across fast and slower memory media without imposing undue overhead on the compute path. In some embodiments, the term “memory pooling” may refer to an architectural approach in which memory from multiple devices, modules, or nodes is collected into a shared resource that can be dynamically allocated to different processors or accelerators. A memory pool may function as a flexible reservoir of capacity that is not tied to the physical boundaries of any single server or compute unit or compute node . Instead, the pooled memory may be made accessible across an interconnection network so that various compute elements can draw upon it when their local memory is insufficient or when workloads shift in a way that requires additional capacity.

In some implementations, the memory system may include an application aware smart caching mechanism in which key value (KV) cache data are placed adaptively in HBM or interconnection fabric-attached (e.g., NVLink attached ) DRAM according to real time access frequency, assessed hotness, and /or instantaneous cache utilization. The memory system may predict large language model (LLM) execution patterns and prefetch frequently invoked layers, thereby placing such patterns and layers efficiently to minimize stalls. Eviction of cached content may follow a multi factor policy that accounts for temporal locality, model weight reuse frequency, and /or burst behaviors in request streams. The caching hierarchy may support high bandwidth prefetching that proactively stages , positions, places or stores frequently accessed layers into HBM to reduce inference latency. The memory system may periodically remap hot regions and/or data (e.g., data that is frequently accessed or updated) and distribute the hot data across multiple HBM channels in order to fully utilize available bandwidth. Cache space may be dynamically allocated in response to the observed activity of multiple AI agents, and memory compression techniques may be applied to increase effective capacity for large models. In multi tenant scenarios, dynamic sharing may partition compute s (e.g., compute node) and memory resources to enable spatial sharing and elastic expansion of an application’s memory footprint into the second tier, thereby avoiding demand paging penalties. High performance applications with large memory footprints may assign warm data/ datasets (e.g., data that is less frequently accessed or updated than hot data) to the second tier and CPU latency critical data to the third tier. In some implementations , controllers (e.g., memory and cache controllers ) may be implemented in an HBM base die to further increase effective memory bandwidth and reduce contention. In some embodiments, the term “ compute ” , “ compute node ” , or “ compute unite ” may refer to a processing element that participates in executing AI, ML, or HPC workloads and may include, for example, a GPU, a CPU, an accelerator core, or any other programmable or fixed function compute engine that interacts with the memory tiers through the interconnection network. A compute node may operate independently or as part of a coordinated group of compute elements that share and access memory resources distributed across multiple tiers. In some embodiments, the term “ controller ” may refer to hardware or firmware logic that manages memory tiers, schedules data placement, handles translation, coordinates RDMA and SHARP operations, or performs aggregation, reduction, caching, or persistency functions. A controller may be located in a compute node, a memory node, an HBM base die, or a memory expansion module, and may work cooperatively with the system’s Memory Management Unit (MMU) and /or interconnect protocol engines.

In some implementations, the memory system may employ or utilize RDMA for memory sharing such that high speed peer to peer transfers proceed across GPUs without CPU bottlenecks. The same fabric (e.g., interconnection structure) may allow dynamic memory pooling across multiple nodes and reduce fragmentation by exposing remote DRAM pools as an extended, unified memory space. The memory system may employ or utilize Direct access DMA (Direct Memory Access) flows to provide seamless synchronization between GPU and CPU memory views without imposing software delays on the application.

In some implementations, the memory system may optimize collective communication using SHARP so that hierarchical aggregation and /or reduction improve training scalability across GPU clusters. By performing partial reductions prior to transmission, the memory system may minimize interconnect bandwidth consumption and thereby reduce latencies in collective operations, including gradient exchange and /or distributed inference synchronization. The memory system may employ p arallel, multi path routing to increase throughput in large scale training . The memory system may offload certain aggregation and /or reduction steps to accelerators located at tier 2 memory expansion nodes to reduce GPU compute demand and /or improve overall pipeline efficiency.

In some implementations, the memory system may provide a dynamic caching mechanism for KV optimization by employing predictive, model aware least recently used ( LRU ) behavior to prefetch active memory pages for currently executing agents into tier 1 memory while retaining less frequently accessed pages in tier 2 memory. the system may perform c ache allocations that adapt s to workload patterns to optimize GPU utilization, permitting kernels with high capacity demands to utilize nearby tier 2 memory. The memory system may maintain region based cross GPU cache synchronization using a hierarchical directory to manage memory regions, thereby promoting reuse and /or reducing redundant loads. The memory system may perform c ache block replacement that is guided by AI driven policies that learn access patterns in real time and prioritize critical model segments.

In some implementations, the memory system may perform a unified virtual address translation that extend s across all memory tiers. In some implementations, the memory system may apply a NVLink Address Mapping (NAM) scheme that enable s direct page access across HBM, DRAM, and /or solid state media so that the application perceives a single address space. In some implementations, the memory system may perform a unified virtual address translation across all memory tiers by adding UALink on top of NVLink. In some implementations, the memory system may perform h ybrid memory paging that implement s NUMA ( Non Uniform Memory Access ) aware placement across tiers to reduce latency, while transparent memory migration may relocate model parameters (e.g., model parameters for AI applications) among tiers without requiring application intervention. The memory system may perform application aware p age management (e.g., aware of model parameters for AI applications and relocating model parameters among tiers based on the access frequency of the model parameters). The memory system may employ huge pages to increase translation lookaside buffer (TLB) coverage without introducing fragmentation. The memory system may provide m ulti GPU shared virtual memory to support coherent access tracking across nodes . The memory system may perform location aware page management that reduce s translation overhead for RDMA and multi node access by caching translation metadata in tier 1 memory.

In some implementations, the memory system may include robust error detection and fault tolerance. In some implementations, the memory system may perform interconnect-based (e.g., NVLink -based or UALink-based ) error correction code ( ECC ) handling that protect s against corruption during high speed transfers. The memory system may apply a distributed checkpointing mechanism that periodically capture s snapshots in interconnect-based (e.g., NVLink -based) DRAM and /or migrate those snapshots lazily to non volatile memory supporting a storage protocol (e.g., NVMe ( Non Volatile Memory Express ), SATA ( Serial Advanced Technology Attachment ) , SAS ( Serial Attached Small Computer System Interface ) , or AHCI ( Advanced Host Controller Interface )) , enabling recovery from partial or system wide failures. Memory pools may self heal by automatically reallocating pages in response to detected faults so that availability is preserved even under component degradation. For example, the memory system may detect that the page is producing repeated read errors, which indicates that the chip might be wearing out. Instead of allowing the error to cause a system crash or data loss, the memory system automatically responds e.g., by moving the data to a healthy page on another memory chip.

In some implementations, the memory system may perform dynamic redundancy allocation that prevent s single point failures in inference pipelines, while redundant checkpointed memory may support kernel migration to improve data locality. For example, the memory system may detect early signs of failure in a DRAM channel used to store intermediate results for the inference pipeline. If this memory region fails without preparation, the entire pipeline may crash because it depends on that region for parameters or activation data. With dynamic redundancy allocation, the memory system automatically creates a redundant copy of the vulnerable pages on a different memory node before the failure becomes catastrophic.

In some implementations, the memory system may include a reinforcement learning based memory scheduler configured to assign memory resources according to real time demand . For example, the memory system may perform AI driven allocation and /or optimization that prefetch es model specific data to tier 1 memory ahead of request arrival. Memory tiering policies may adapt to workload intensity, data locality, and /or agent execution requirements . The memory system may perform energy efficient scheduling that balance s power consumption with computational throughput.

In some implementations, the memory system may employ NAND based multi tier memory expansion that extend s the memory pool available to applications. In some implementations, the memory system perform d ata movement into and across the expanded tiers in a fully hardware managed manner that may not require modifications to application software, thereby simplifying adoption and preserving performance.

In some implementations, the memory system may provide fast and persistent startup and resume capabilities for virtual machines (VMs) , containers, and /or FaaS. NAND backed memory (e.g., memory that uses NAND flash storage as its underlying physical medium) may serve as a persistent state store for virtualized workloads, enabling rapid state transitions and resume operations from regions reserved within the memory pool. For example, b y maintaining VM, container, or FaaS state in reserved regions of the memory pool, the system can resume execution from previously saved checkpoints without requiring a full reload from external storage.

In some implementations, the memory system may manage startup and resume operations entirely in hardware. The startup and resume operations may include on the fly migration of VM or container states between accelerators or compute nodes, so that workloads can be relocated based on resource availability or data locality. The same hardware controlled mechanism may support rapid execution of both hot and cold functions in a FaaS environment. Hot functions may start immediately from cached state stored in higher tier memory, while cold functions may retrieve their initial state from the NAND backed memory tier without significant cold start delays. As a result, the system may provide efficient, low latency activation of virtualized workloads even under dynamic or multi tenant operating conditions.

In some implementations, the memory system may a dual mode memory/storage that transparently convert s persistent data into files recognized by the filesystem. In some implementations, a file mapping component resident in NAND based memory may translate data in physical address space into blocks or objects addressable by the filesystem, and conversion may be triggered through an application programming interface or by instructions by one or more controllers .

In some implementations, the memory system may provide NVMe over Fabrics ( NVMe oF ) target functionality that is integrated directly into the storage subsystem so that data stored as objects, blocks, or files becomes immediately accessible across a dedicated storage interconnection network. For example, when a dataset is written into the NAND backed memory tier, the system may expose that dataset through an NVMe oF interface, allowing remote hosts or accelerators to read or write the data without using intermediate storage servers. In some implementations, t he memory system may include an optional accelerator embedded within the NAND memory module. This accelerator may operate as an NVMe oF target device and may support transport over TCP or over remote direct memory access. As an example, when a GPU server requests a block of training data stored in the NAND tier, the embedded accelerator can serve the data directly over RDMA, which avoids CPU mediated copies on the host side. This can reduce latency and prevent host CPUs from becoming bottlenecks during large scale data transfers.

In some implementations, the memory system may provide a fast demand paging mechanism that allows virtual addresses to use non storage devices, such as higher tier memory or interconnect attached DRAM, as intermediate swap space. In this approach, portions of higher tier memory may be configured to act as part of the system’s swap region, which enables pages to be fetched much more quickly than in disk backed paging. This can reduce stall times that would otherwise occur when a page fault forces the system to retrieve data from a slow storage device.

In some implementations, the memory system may provide NVMe oF initiator capabilities that may permit GPUs or other accelerators to directly access remote storage nodes in the network. T he memory system may include an NVMe oF initiator configured to offload I/O overheads to specialized hardware . In some implementations, the memory system may include an optional accelerator embedded in NAND that may act in an initiator role to reduce host utilization and improve throughput. Transport may proceed over TCP or RDMA, depending on deployment requirements, thereby enabling direct, high performance data paths from compute to storage without compromising isolation or manageability.

In some implementations, the memory system may provide a scalable hierarchical memory expansion for accelerator that extend s accelerator’s memory using interconnect-attached DRAM or HBM, providing high-speed model execution to accelerators without sacrificing performance. In some implementations, the memory system may provide an application-aware smart caching mechanism that can dynamically place KV caches and LLM model parameters in either HBM (tier-1) or interconnect-attached DRAM (tier-2) based on access patterns.

In some implementations, the memory system may provide a hierarchical memory caching system that can dynamically migrate KV caches and /or LLM parameters between HBM (tier-1) or interconnect-attached DRAM (tier-2), and persistent NAND (tier-3) to optimize memory bandwidth. In some implementations, the memory system may provide a unified multi-level virtual address mapping scheme (e.g., Interconnect Address Mapping - IAM) that can enable seamless memory access across memory tiers.

In some implementations, the memory system may provide a self-healing error management mechanism that may detect and corrects faults in interconnect-attached DRAM and HBM memory pools. In some implementations, the memory system may provide an AI-driven memory scheduling and optimization framework that can dynamically assign GPU memory resources based on real-time multi-agent AI workloads.

In some implementations, the memory system may provide an RDMA-based GPU memory access system that can enable direct peer-to-peer memory transfers between GPUs across multiple nodes without CPU involvement. In some implementations, the memory system may provide a SHARP-optimized collective communication protocol that can reduce network congestion and improves AI model synchronization efficiency.

In some implementations, the memory system may provide a multi-node dynamic interconnect-based memory pooling system that can enable multiple GPUs to share and access memory across different computing nodes. In some implementations, the memory system may provide a fast and persistent mechanism for FaaS, containers, virtual machines and other GPU execution in the cloud.

In some implementations, the memory system may provide a mapping mechanism that can transparently convert data in the physical layer of persistent memory to an object/block/file accessible by the storage system and/or filesystem. In some implementations, the memory system may include a hardware device integrated to the system and configured to connect the persistent memory to other parts of the storage systems connected to the interconnection network.

In some implementations, the memory system may avoid the demand paging mechanism that rel ies solely on the storage system, and allow portions of the memory to be used as a swap space for the host and accelerators. In some implementations, the memory system may allow the multi-tier memory to behave as an initiator of the storage system, allowing the accelerator or the GPUs to directly access other storage devices within the storage network.

In some implementations, a memory system can extend the current accelerator interconnection network protocols such as NVLink, NVSwitch, CXL, UALink, UCIe or Ethernet. In some implementations, the memory system can provide memory-based expansion to the interconnection network as tier-2 memory, and the NAND-based persistent memory (e.g., NVMe storage ) as tier-3 memory. The memory expansion and NVMe storage expansion can be compatible with interconnection network protocols and can be accessible by accelerators such as GPU as well as general purpose host CPU under the same address space.

In some implementations, w ith the tiered memory system, the memory system can include three tiers of memory expansion nodes, each with different tradeoffs. The first tier of memory (tier-1) may include HBM memory that is local to the accelerator (for example, HBM on the GPUs).

In some implementations, the second tier of memory (tier-2) may include one or more interconnection network connected memory nodes , each including a volatile memory (such as HBM or DRAM). This memory tier can be accessed by the accelerators . The memory system can provide a multi-tier memory management unit (e.g., one or more controllers) that expands the memory pool available directly to the accelerator, allowing applications running on the accelerator to utilize the extra memory using high-speed protocol. This memory node can be utilized or configured for smart caching, d ynamic KV-cache, and /or can be in coordination with the tier-3 memory to enhance reliability and /or error handling.

In some implementations, the tier-2 memory can include a combination of compute units (or compute nodes) in the forms of a general-purpose CPU and/or accelerators configured to operate the devices. This compute unit can perform aggregation and reduction operation s either by offloading the tier-1 SHARP or in conjunction with tier-1 SHARP as a hierarchical aggregation/reduction operation on the extended memory in support of the SHARP technology. For example, consider a workload in which multiple GPUs in tier 1 are processing segments of a large model and repeatedly generate intermediate results that may be aggregated across the system. Instead of sending all intermediate values to the tier 1 SHARP engine directly, the tier 2 compute unit, such as a CPU or a small accelerator embedded within the memory expansion node, may first combine the values from several memory regions in tier 2. The partially reduced result may then be forwarded to the tier 1 SHARP engine, which completes the remaining aggregation.

In some implementations , the AI/ML workload including multi-agent applications , can take advantage of the abundant capacity in the tier-2 memory through additional KV-cache, precomputation on a much larger pool of data using extended SHARP, while the caching policy allows the data to be accessed without the performance overhead due to the memory expansion, and benefit from the high bandwidth from the integration with network protocols such as NVLink.

In some implementations , t o improve the tail latency of multi-agent workload, tier-2 memory can be used to store less frequently used AI agent s , and operate in conjunction with the tier-1 memory to proactively and transparently prefetch crucial parts of the stored agents when the system detects possible need based on the applications’ behavior. This prefetching can be triggered by patterns observed in the application’s behavior, such as a user interaction that typically precedes the activation of a specific agent. For example, consider a system that hosts dozens of specialized AI agents, only a few of which are active at any given time. A document analysis agent may be used only occasionally and is therefore stored primarily in tier 2 memory rather than in the high bandwidth tier 1 memory. If the system detects that a user has opened a file type that frequently uses that agent, the memory system may proactively fetch the agent’s initialization code, embeddings, or model layers from the tier 2 memory into tier 1. This can prevent long latency when rarely used agents, which are typically paged into the slow storage devices, suddenly have higher demands.

In some implementations, the tier 2 memory may operate as both a memory resource and a basic compute element that supports the functions required to participate in the interconnect protocol. This tier 2 memory may be accessible to the GPU as an extension of its main memory, allowing the GPU to treat the tier 2 region as an expanded addressable space. The tier 2 storage may include volatile memory and may reserve portions of that memory for storing user data, for maintaining a table used to translate virtual addresses into physical locations within the tier 2 devices, and for holding metadata that assists in managing the memory.

I n some implementations, the tier 2 memory may move data according to a caching policy that identifies how data should be promoted or demoted across the memory hierarchy. Under this policy, data that is accessed less frequently may be migrated from tier 2 into higher tier memory such as tier 3 (data demotion) , while data that is accessed more frequently may be migrated from tier 2 into lower tier memory such as tier 1 (data promotion) . The system may apply these movements either passively in response to observed access patterns or proactively when the policy predicts that a particular region of data will soon become performance critical. The caching policy may be configured by system software or may be pre programmed into the tier 2 controller. In some implementations, the policy may incorporate artificial intelligence techniques, such as a perceptron based predictor, to decide which data regions are likely candidates for promotion or demotion.

In some implementations , the t ier-3 memory may include a DRAM cache and NAND devices such as NVMe-based SSDs that share the NVLink fabric either directly to the GPU or through NVSwitch network. This memory tier may operate closely with the memory subsystem as the last pool of memory that can also be shared with the storage system, allowing the GPU to directly access the slower memory and the NAND device through the interconnect fabric. The tier -3 memory can provide persistency support for the GPU, enabling other tiers to temporarily move the data reactively based on the compute demand or prefetch data from the tier-3 memory to its respective tier, and used as the pool to store intermediate container and /or virtual machine images as well as FaaS states in order to lower the start/resume latency. The DRAM cache in tier-3 memory can serve to lower the overall performance impact of the slower NAND flash and can be used as an inclusive cache storing hot or frequently used data based on the caching policy (for example, an Least Recently Used (LRU) -based caching policy or AI-based policies that adapt to applications’ demand).

In some implementations, the tier 3 memory may enable direct operation on the data stored within that tier as part of a broader storage cluster. For instance, when the system stores large datasets or model checkpoints in the tier 3 NAND backed memory, applications or accelerators may operate on that data in place rather than copying it into higher tiers. This allows tier 3 memory to function not only as a capacity tier but also as an active participant in storage level computation. The larger capacity of the tier 3 memory can also serve as a fast demand paging region or an accelerated swap space for virtualized environments. As an example, when a virtual machine temporarily exceeds the capacity of its tier 1 or tier 2 memory allocation, the system may place inactive pages into the tier 3 memory instead of sending them to a slower disk based swap device. When those pages are needed again, they can be retrieved more quickly from tier 3 than from conventional storage, resulting in shorter stall times and smoother execution.

In some implementations, an optional accelerator may be integrated into the tier 3 expansion device. This accelerator may allow the tier 3 device to function as an initiator that can directly interact with the rest of the storage system. For example, a GPU running an inference or data analysis pipeline may request training samples or intermediate files stored in the storage cluster. Rather than routing the request through a host CPU, the accelerator embedded in the tier 3 device can issue the request directly, enabling GPU initiated data movement and reducing host CPU involvement.

In some implementations, the memory system may use a combination of components distributed across different tiers of the memory hierarchy to manage data access requests originating from accelerators and from the memory expansion devices themselves. These components may include an interconnect fabric controller, such as a controller associated with an NVLink fabric, together with a cache controller located on nodes attached to the interconnection network. In addition, compute units or accelerators located on memory expansion nodes, such as those associated with tier 1 or tier 2 memory, and compute units or accelerators located on NVMe based storage expansion nodes associated with tier 3 memory, may also participate in data access coordination. Through the interconnection network, these distributed components can collectively manage requests initiated by GPUs or other accelerators, as well as requests generated internally by the tier 2 or tier 3 expansion devices.

In some implementations, the memory system may use AI assisted management techniques that operate in either a centralized arrangement or a distributed arrangement, and may function in a flat organizational structure or in a hierarchical structure. These AI assisted mechanisms can operate alongside existing memory management components, including the CPU memory management unit, the input output memory management unit, the controllers for interconnection networks such as NVLink, Compute Express Link, UALink, or Ethernet, the extensible memory controller, and the various coherency protocols used throughout the system. The memory system may autonomously determine how data should be mapped, placed, or migrated across different memory tiers and may move the data transparently, allowing applications to make use of expanded memory resources without requiring manual data movement instructions.

In some implementations, the memory system may provide a caching scheme for multi-tier memory . The caching scheme can take advantage of the application behavior by storing profiled applications’ data that can include access frequency, hotness information, data sharing information, access strides and /or other properties that are useful to determine the utility of each respective memory tier for storing the data.

In some implementations, the memory system may use a multi model caching policy in which several predictors operate together to guide data placement decisions. These predictors may include small artificial intelligence models, perceptron based predictors, application aware heuristics, and /or traditional least recently used policies. The predictors may combine their outputs to determine an overall caching strategy that increases cache utilization, reduces memory access latency, improves effective bandwidth available to each application, and enhances application performance. For example, if both the perceptron model and the application aware predictor anticipate that a particular tensor or model layer will be accessed repeatedly in an upcoming computation step, the system may proactively promote that data into a faster tier to avoid stalls during execution.

In some implementations, the memory system may provide reduction/aggregation operation s (such as NVIDIA ® SHARP) for data stored in both tier-1 memory and on tier-2 memory. A tier-2 node can operate as an offloaded device for tier-1 data demanding SHARP operations . I n this case , a GPU can send a command to the tier-2 node, and the compute unit in tier-2 node can perform a reduction and aggregation operation of data connected within the connection network (e.g., NVLink interconnect ) and forward the results of the operation to the requesting GPUs. Multiple tier-2 nodes in the interconnect can perform aggregation and reduction operations in parallel to serve multiple GPU nodes at the same time.

In some implementations, the interface between the tier 2 memory and other nodes, both within tier 2 and across other tiers of the system, may be supported by one or more cache controller s that maintain cache coherency among all nodes connected through the interconnection network (e.g., NVLink interconnect ) . This coherency ensures that when data stored in the multi tier memory is modified in one location, the cache controllers (e.g., hardware controller) can update or invalidate corresponding copies elsewhere without requiring software involvement.

In some implementations, the tier 2 memory may also support remote direct memory access (RDMA) operations, allowing GPUs or other accelerators to perform data transfers through RDMA. In some implementations, the tier 2 logic may further accelerate RDMA protocol handling. This tier 2 logic may include dedicated accelerators, memory controller circuitry, and/ or general purpose compute units such as embedded x86, RISC V, or ARM CPUs. For example, when a GPU issues an RDMA read request for data located in tier 2, the embedded compute unit in the tier 2 device may prepare and serve the request directly, reducing latency and minimizing reliance on the host CPU.

In some implementations, data stored in the tier 2 memory may exhibit different characteristics across the various workloads running on the GPUs, and these differences can influence how effectively the data can be compressed. To accommodate this variability, the processing core within the tier 2 memory may apply multiple compression techniques, each suited to different types of multi agent or HPC workloads. The compression technique used may be selected through a programming interface or may be pre configured within the tier 2 controller. The choice of compression method may depend on several factors, including the observed behavior of the running applications, hints provided by the user or compiler during code generation, the system’s needs with respect to data retrieval latency, achievable compression ratio, and /or available memory capacity. Through this adaptive compression strategy, the tier 2 memory can balance performance, efficiency, and memory utilization across a broad range of workloads.

In some implementations, the tier 2 memory expansion may be configured and partitioned in accordance with the GPU’s partitioning policy to provide isolation among different users or workloads. For example, an extended version of NVIDIA GRID may assign specific subsets of tier 1 and tier 2 memory nodes to individual GRID instances, allowing each client to operate within an isolated region of the GPU and memory resources. When this partitioning feature is disabled, the tier 2 memory expansion may function as part of a larger shared memory pool that is accessible to all GPUs connected through the interconnect.

In some implementations, the tier 2 memory and its associated controllers may provide redundancy support by duplicating data, tracking the locations of the duplicated copies, and /or periodically generating updated checkpoints. These checkpoints may be used to recover data for active regions in tier 1 memory that become corrupted or experience uncorrectable errors. For example, if a model layer stored in tier 1 memory encounters an error during inference, the tier 2 controller may retrieve a clean copy from one of its checkpointed regions and restore it without requiring software intervention. The tier 2 memory devices may also incorporate standard error detection and error correction techniques, such as ECC mechanisms, to further enhance data integrity throughout the memory hierarchy.

In some implementations, one or more memory controller s within the tier 2 memory device may operate together with one or more hardware accelerator s to monitor activity across the memory channels and /or banks in the tier 2 expansion node. By profiling access patterns, the controller s may identify hot channels or hot banks that are experiencing disproportionately high traffic. Once such conditions are detected, the accelerator s may work with the management unit (e.g., one or more controllers in the system) to migrate data so that heavily accessed data is redistributed across multiple channels and banks. This redistribution can improve bandwidth utilization and raise overall performance for multi agent workloads and other bandwidth intensive applications.

In scenarios where HBM is used as the memory medium within tier 2 nodes, either through a chiplet based interconnection network shared with accelerators or GPUs, or through a separate expansion module attached to the accelerator or GPU interconnect, a cache controller and /or a memory controller may be implemented on the base die of the HBM itself. Locating these controllers on the memory base die may reduce latency and /or simplify data movement paths, since memory management operations can be performed closer to the physical storage arrays rather than on an external expansion card or on the compute side of the system.

In some implementations, the tier 3 memory, such as an NVLink attached NVMe expansion module, may include one or more NAND based devices. These devices may include NVMe SSDs or other forms of nonvolatile memory that provide a larger but slower memory tier for use by the lower tiers of the memory hierarchy. In some implementations, the tier 3 memory may also be implemented as CXL.H memory (e.g., heterogeneous CXL memory) that combines raw NAND with a DRAM or HBM cache. The larger memory pool available at the tier-3 may be managed by a hardware accelerator that oversees data placement, retrieval, and /or migration across the multi tier system. In some implementations, u nlike conventional NVMe devices, a NAND expansion device integrated into the interconnect fabric may be compatible with the NVLink protocol. Locally, the device may use NVMe or RDMA protocols, which enables GPUDirect - style storage access to remote devices over the interconnect. As a result, a GPU may issue an RDMA request directly to the tier 3 expansion device and retrieve the requested data without relying on the host CPU, thereby reducing latency and increasing throughput in GPU centric workloads.

In some implementations, t here may be three main functions of tier-3 memory. First, the tier-3 memory in the multi-tier memory system may be configured to handle cold and stale data such as AI agent models that are not being actively used, and allow the lower-tier memory to prefetch these data based on a prefetching policy. Unlike the usual method to access NAND-based memory that relies on the system software, either through the host’s CPU or through specialized software stack such as NVIDIA ® GPUDirect storage, to access block-level data in the flash storage, the tier-3 memory expansion can allow flash devices to operate in the memory-level rather than at the storage-level. This memory-level expansion can extend the address space for all data used in the GPU kernel or software on the accelerators and allow direct access to these data using memory address es using the same memory management unit without relying on the system software.

Second, the non volatile nature of the tier 3 memory can provide persistence for the system. In some implementations, the memory system may periodically generate checkpoints that capture an updated snapshot of the running applications. These non volatile checkpoints can then be used to improve the reliability of the memory hierarchy. During operation, the tier 1 and tier 2 memories may take snapshots of active data and store them in the NVMe devices that form the tier 3 memory. Updates to the data can be applied lazily by notifying the corresponding regions in the tier 3 snapshot through the interconnect, such as NVLink or UALink. If the system encounters a failure or an unrecoverable error, the most recent snapshot stored in tier 3 can be reloaded into the tier 1 or tier 2 memories through the interconnect, allowing the GPU to resume execution without performing a full restart. For interconnects with lower bandwidth, such as CXL or Ethernet, the system may generate checkpoints less frequently so that snapshot traffic does not saturate the available bandwidth.

In some implementations, the memory system can provide a checkpointing mechanism in which the DRAM cache serves as a staging area for updates before they are periodically written to the persistent memory in the tier 3 RAW NAND. T he persistent memory subsystem can track writes that occur in volatile memory and temporarily store these updated values in the DRAM or HBM cache. When the tier 3 memory receives a checkpoint command, or when a timer triggers a checkpoint interval, the updates stored in the DRAM cache are committed to the persistent NAND array. This approach can support different forms of persistent memory management , e.g., at least one of a update based persistency model and a log based persistency mode l . In a update-based scheme, all modified data may be captured during each checkpoint and written to tier 3. In a log based scheme , only the changes to the data may be captured in a log structure, and these logs may be written to the persistent memory so that the GPU can later replay the updates and recover its execution state from the most recent checkpoint.

In some implementations, i n the update-base scheme, non-persistent data updates can be detected using dirty bits in their respective memory tier. Data blocks with dirty bits can be periodically updated in the DRAM cache in tier-3 memory, and these updates can be flushed into the persistent NAND devices making a checkpoint. On the other hand, i n the log-based scheme, when there is an update to data blocks, a log can be generated. Series of update logs from tier-1 and /or tier-2 memory can be streamed to the DRAM cache and eventually stored in the NAND memory, allowing the system to recover from a failure by replaying these logs.

Third, tier-3 memory can be used as a large pool of persistent memory for cloud instances ( e.g., container image, container states, virtual machine images, FaaS services). In some implementations, the memory system can provide a quick start mechanism for containers, virtual machines, and FaaS in which execution states and images are gradually demoted across memory tiers. In this scenario, when a user image is paused due to a time sharing policy and may need be removed from the accelerator, the system need not swap the image and its state to a NAND flash storage device. Instead, the image and its associated execution state may be migrated and optionally encrypted within the tier 3 memory. Because these images continue to reside within the address space managed by the hypervisor or container management software, the data stored in tier 3 , e.g., data including the portions that remain temporarily in the DRAM cache of the tier 3 device , can act as a victim cache for state that is considered cold.

In certain scenarios, r esuming an image from tier 3 memory may incur significantly lower latency than restoring it from conventional storage. In some implementations, the memory system may simply move the execution state back to the accelerator’s compute unit. This may include restoring instructions, program counters, instruction pointers, and /or any relevant cache state to their corresponding destinations, allowing the accelerator to resume execution promptly. A similar mechanism may be applied to services operating under a FaaS model. By keeping function images and state materialized within the tier 3 memory rather than loading them from disk, the memory system can start and stop functions quickly, avoiding cold start delays and enabling rapid, on demand execution.

In some implementations, the tier 3 memory may be configured to operate in a headless mode that relies on an embedded processor for added flexibility. A headless configuration allows the NVMe devices within the tier 3 memory to communicate directly through interconnection protocols such as NVLink, Compute Express Link, or UALink without requiring system software on the attached nodes. Instead, hardware accelerators and the embedded processor within the tier 3 device may manage protocol handling, command processing, and /or data movement internally.

In some implementations, similar to the tier 2 memory expansion, HBM may be used as a caching layer in the tier 3 device. When HBM is deployed either within the same chiplet based interconnection network as the accelerators or GPUs, or on a separate expansion card attached to the GPU or accelerator interconnect, the cache controller and memory controller may be integrated directly into the base die of the HBM. Locating these controllers on the HBM base die rather than on the expansion card or compute side can reduce latency and streamline memory management operations by placing the control logic closer to the physical memory arrays.

In some implementations, the memory system can perform a multi tier memory management that operate s as a central mechanism that enables memory across all tiers to appear within a unified virtual address space. This memory management framework may function cooperatively with the existing memory management units of accelerators or GPUs, as well as with the host system’s memory management unit. In addition, the multi tier memory management may oversee the operation of the tier 2 and /or tier 3 memory regions based on policies determined by the memory management logic associated with the interconnection network attached memory. Through this coordinated management, the memory system can maintain a consistent address space and dynamically control data placement across the tiered memory hierarchy.

In some implementations, the memory system can perform fast address translation to remote nodes in the tier 1, tier 2, and /or tier 3 memory by propagating a subset of relevant page table entries to the appropriate memory tiers. These propagated page table entries may be cached in the lower tier memory, such as tier 1, and may also be stored in the interconnect controller, which may include components such as an NVLink controller, an NVSwitch controller, or a CXL switch. When a compute node, such as a GPU, accelerator, or CPU, needs to access a page located on a remote node, it may first consult or refer to the cached page table entries. If a matching entry is found, the compute node can translate the virtual address and directly access the physical location on the remote node without performing a full page walk through the CPU’s input–output memory management unit or the host operating system’s page table. The memory system can control a ccess to the cached page tables using a virtual machine identifier or an address space identifier to ensure that memory protection and isolation requirements are maintained across all nodes in the multi tier memory system.

In cases where an accelerator or GPU includes its own local memory management unit that supports address translation within the device’s local address space, some implementations may incorporate a cache controller to coordinate the movement and remapping of data across the memory tiers. By adding this cache controller, the memory system can perform address translation using the GPU’s local translation structures rather than relying on the input–output memory management unit (IOMMU) . This approach can avoid the performance overhead associated with IOMMU based translation and eliminates the need for additional external controllers, while still maintaining correct data placement and consistency across the multi tier memory hierarchy.

In some implementations, d ata may be temporarily stored in the tier 3 memory as nonvolatile storage or as part of the broader storage space. From there, the hardware may transparently migrate the data into the appropriate memory tier, including tier 1, tier 2, or the DRAM cache associated with the tier 3 device. In addition to hardware initiated movement, the system’s demand paging mechanism may also migrate data between tiers based on application behavior or memory pressure.

In some implementations, the memory management unit and /or the control logic of the tier 2 and tier 3 memories may decide to promote or demote data based on how stale the data has become across nodes connected through an interconnect fabric (e.g., NVLink ) . Promotion refers to moving a page into a faster, lower tier of memory, and demotion refers to moving a page into a slower, higher tier of memory. System software may influence these decisions, but the hardware memory management unit performs the actual data migration. When a change to data mapping is required, the system may notify the relevant memory levels, temporarily block access to the affected region, update the appropriate page table entries, and then restore access once the updated page table near the compute unit, such as a GPU or CPU, is synchronized.

In some implementations, the multi‑tier memory system can support fast demand paging. Operating systems such as Linux and Windows may treat tier‑2 and tier‑3 memory as an extended swap space, which provides a large pool of memory for the virtual address system. Using these tiers as swap space can significantly reduce the latency of demand paging for pages that are not stored in main memory. Traditionally, a page fault would require the system to retrieve data from a slower solid state drive. In this multi‑tier design, the fault can be serviced from tier‑2 or tier‑3 memory, which results in noticeably faster response times and fewer stalls caused by paging activity.

In some implementations, the memory system may provide optional transparent integration with the file system and /or the storage system. After data is stored in the persistent memory located in tier 3, the memory system may provide a mechanism that converts this data into blocks or objects that can be accessed by existing storage and /or file system infrastructure. This mechanism allows data that was originally handled through load and store operations to be transformed into block or object formats without software intervention. As a result, the data can be viewed and accessed by other devices connected to the network as part of the broader storage system, enabling transparent migration between memory based operations and storage based operations.

To enable this functionality, the memory system may include an optional port that connects the tier 3 memory to a separate network that hosts storage servers. In this configuration, a Non Volatile Memory Express over Fabrics ( NVMe-oF ) hardware accelerator may operate as the driver for the NAND devices and may manage the interface and command handling for input and output operations originating from the storage servers or other connected hosts. The NVMe-oF accelerator may allow devices on the separate network to perceive the tier 3 memory as a standard NVMe device and to interact with it as part of the storage system. In this role, the tier 3 memory may operate as a storage target that presents object or block storage to the remainder of the cluster. With this connection in place, the tier 3 memory may serve as a storage node for any other hosts and may appear as an integrated component of the cluster’s storage system through the NVMe-oF accelerator.

In some implementations, the memory system may support two modes of operation for data stored in the tier 3 memory and provide a metadata registry that tracks the status of data blocks. Using this approach, the memory system can enable full integration between the memory based data store and the storage based data store without requiring any data movement within tier 3 memory or between tier 3 memory and the rest of the storage system. Because tier 3 memory is nonvolatile and retains all stored data, this approach can satisfy the persistence requirements of a storage subsystem. As a result, data that resides in physical memory can be transitioned into block or object form for use by the storage system in a transparent manner.

To support this capability, in some implementations , the memory system can include a separate metadata registry that tracks each block of data and records whether it is operating in memory mode or storage mode. In some implementations , a t any given moment, data stored in tier 3 memory may operate in one of these two modes. When operating in memory mode, the data can be accessible only through load and store semantics and may be managed by internal address translation structures such as the TLB ( translation lookaside buffer ) and memory management unit. When operating in storage mode, the data is accessible to GPUs, accelerators, hosts, and other storage devices through input and output commands. In some implementations , the metadata registry may maintain a file mapping component that tracks the metadata required to present tier 3 data as blocks or objects to a file system. In some implementations , hardware may interface with existing file input and output commands, with extensions that support conversion of data between physical memory format and block or object format. When such a conversion command is received, the metadata registry may update the mode of operation for the associated data blocks and transition the associated data blocks between memory mode and storage mode accordingly.

In some implementations, the memory system may include an NVMe-oF initiator accelerator to improve integration between accelerators, GPUs, and the rest of the storage infrastructure. This initiator accelerator can offload key tasks and allow accelerators or GPUs to access and operate NVMe based storage devices directly, without relying on host CPU threads or GPU threads to run operating system level storage software. In some implementations, hardware including input and output processors and command processors can receive storage commands from the accelerator and perform the NVMe-oF operations on its behalf. By moving these responsibilities (e.g., responsibilities for such NVMe-oF operations) into dedicated hardware, the memory system can enable accelerators and /or GPUs to interact with remote storage devices with significantly lower overhead. In some implementations, the code paths that would normally execute on the host or GPU can be offloaded to the initiator accelerator, allowing storage operations to occur more efficiently and without the performance penalties associated with software based I/O processing.

There are differences between a conventional accelerator or GPU based storage access flow and the flow enabled by embodiments of the present disclosure . In a conventional system, storage access may require the host CPU to manage data movement between the storage cluster, where blocks and objects reside, and the compute nodes that include CPUs, accelerators, or GPUs. This conventional model may depend on CPU side processing or GPU programmable threads to run the storage software stack and issue the I/O operations. In contrast, in some implementations, the memory system can provide hardware support for an initiator that allows GPUs and /or accelerators to operate remote SSDs and NVMe devices as if they were local. The initiator hardware can handle command processing and I/O management without requiring additional computation by the host CPU or by GPU programmable threads. As a result, accelerators can perform storage operations directly and at lower overhead.

In some implementations, t he target side accelerator and the transparent dual mode operation of the tier 3 memory can enable direct access between compute nodes and the data stored in the tier 3 memory. In this configuration, other nodes in the compute cluster can treat the tier 3 device as part of the storage system, allowing storage mode data to be accessed directly through I/O commands and memory mode data to be accessed through load and store operations, all under hardware managed control.

Embodiments in the present disclosure have at least the following advantages and benefits. First, embodiments in the present disclosure can provide a significant advantage by allowing accelerators such as GPUs to operate with access to a substantially larger and more flexible memory pool than what is available through local HBM alone. Because the system integrates tier 2 interconnection attached DRAM/HBM and tier 3 NAND backed persistent memory into a unified address space, applications can access far greater capacity without manually orchestrating data transfers or suffering the severe penalties normally associated with paging to host memory or SSDs. This expanded and transparently managed memory space enables large AI and HPC workloads , e.g., workloads with multi agent pipelines, extensive KV caches, and multi terabyte corpora , to execute without the fragmentation, underutilization, and performance bottlenecks characteristic of conventional GPU clusters.

Second , embodiments in the present disclosure can provide an improvement in distributed computation efficiency by enabling in network or near memory operations such as aggregation, reduction, caching, and translation to be executed within the tier 2 and tier 3 nodes rather than solely on GPUs or CPUs. Offloading these operations to specialized hardware located in the memory expansion layers reduces network traffic, lowers synchronization overhead, and frees valuable GPU cycles for compute rather than communication. As a result, collective operations, model parallel workloads, and multi node inference and training tasks complete more rapidly, with lower latency and greater scalability across a larger number of accelerators.

Third , embodiments in the present disclosure can provide a persistent and /or hierarchical memory system that offers improved reliability and continuity of execution. Tier 3 NAND storage functions as a non volatile layer that can maintain checkpoints, container states, virtual machine images, and function as a service data, enabling rapid pause and resume behavior and mitigating the cold start delays common in shared GPU environments. By supporting hardware managed checkpointing, log based recovery, and transparent demotion and promotion of data among tiers, the architecture allows long running AI or HPC jobs to withstand failures, preemptions, or tenant transitions with minimal disruption, while also improving overall system utilization in multi tenant or cloud deployments.

With the foregoing in mind, the figures and description below illustrate various examples of systems and/or methods for adapting operations based on network conditions. It should be noted that the figures and description below are non-limiting examples and can be implemented as any of various other configurations while remaining within the scope of the present disclosure.

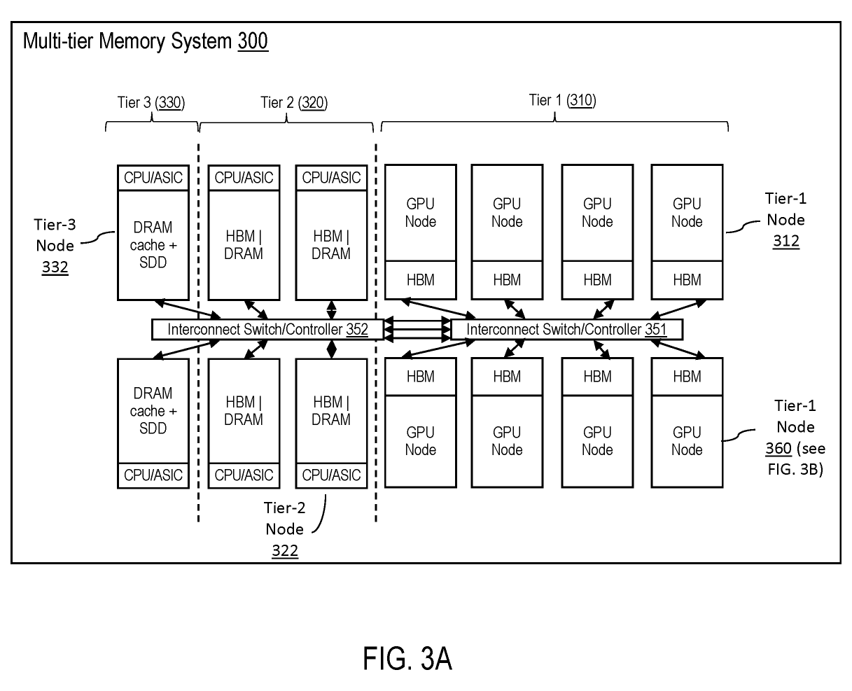

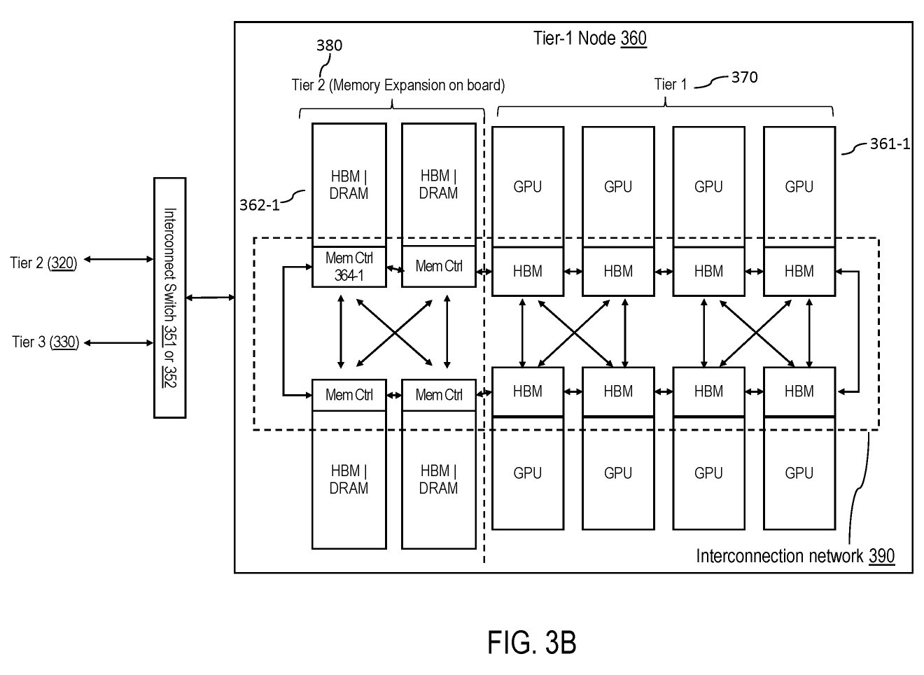

FIGS. 3A and 3B are diagram s of a multi-tier memory system 300 , according to an example implementation of the present disclosure. In the multi tier memory system 300 , a first tier 310, a second tier 320, and a third tier 330 are interconnected to compute and memory resources using one or more interconnect switches/controllers (e.g., NVSwitch /controller) 351, 352 that provide all to all connectivity across tiers. The first tier shows Tier 1 node(s) 312 hosting GPU node(s) with local HBM, the second tier shows Tier 2 node(s) 322 comprising interconnection attached volatile memory (e.g., HBM or DRAM) together with control logic, and the third tier shows Tier 3 node(s) 332 comprising a DRAM cache and/or SSD resources managed by an on board CPU/ASIC ( Application Specific Integrated Circuit ) . The first tier 310 may include a Tier 1 node 360 (see FIG. 3B) having configurations shown in FIG. 3B .

FIG. 3B depicts an example Tier 1 node 360 coupled to the fabric (e.g., interconnect switches/controllers 351 or NVSwitch 352) and interacting with the second tier 320 and the third tier 330 (labeled NVMe Tier 3) through an interconnection network 390. In some implementations, the Tier 1 node 360 has configuration similar to that of the interconnection network 220 shown in FIG. 2. Within the node 360 , the tier 2 memory expansion on board 380 may include multiple HBM/DRAM devices each controlled by a memory controller 364-1 , and the tier 1 memory 350 may include GPU/HBM nodes 361-1. The tier-1 memory 370 and the tier-2 memory expansion 380 may be connected using a local interconnect (or interconnection network) 390 .

As shown in FIGS. 3A and 3B, the interconnection network may present a unified address space that is accessible by both GPUs and host processors. This unified view allows the tiered memory system to balance bandwidth, latency, capacity, and persistence across the different memory tiers. The embodiment is compatible with a variety of interconnection technologies, including NVLink, CXL, UALink, Ethernet, UCIe , or the like . In the example that uses NVLink and NVSwitch, all components are connected according to the NVLink protocol and follow the NVLink topology. NVSwitch devices may provide all to all connectivity among the memories in all three tiers, ensuring that each node can reach any other node in the system.

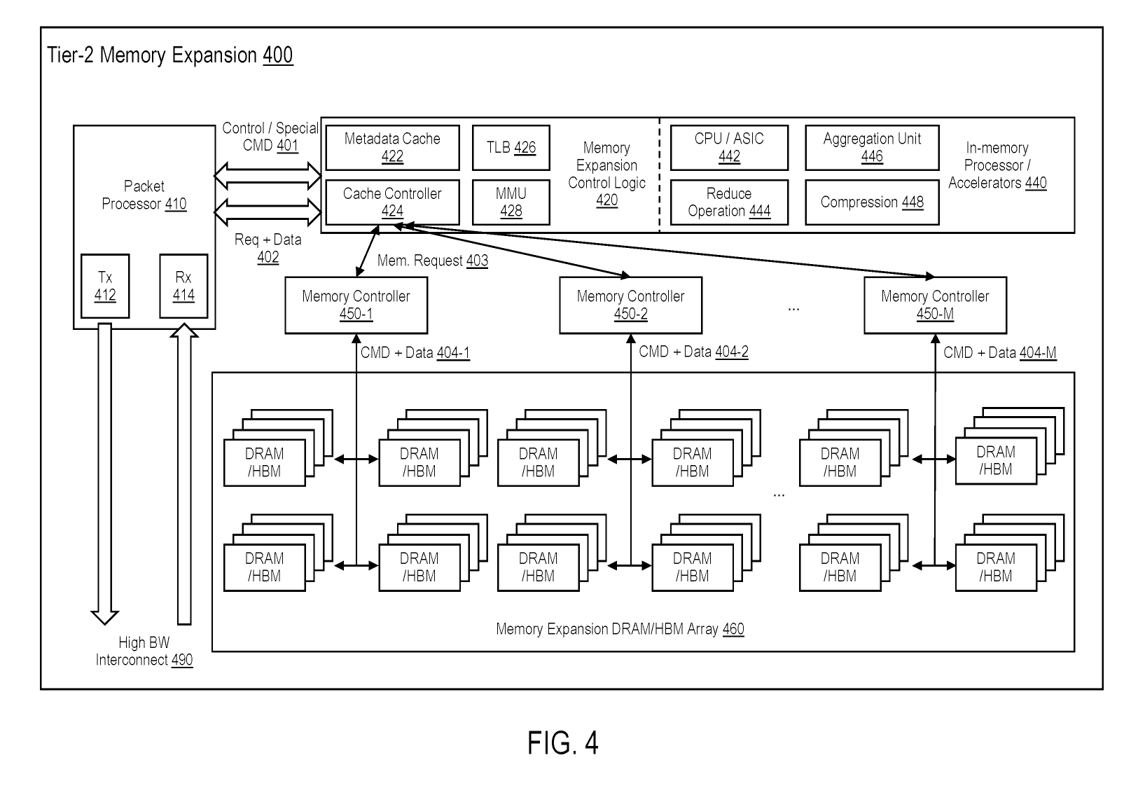

FIG. 4 is a diagram of a tier-2 memory expansion 400 , according to an example implementation of the present disclosure. The t ier 2 m emory e xpansion 400 may attach to a h igh bandwidth (BW) i nterconnect 490 (e.g., interconnect switches/controllers 351, 352 in FIG. 3A) and provide services through a m emory e xpansion DRAM/HBM a rray 460 managed by m emory e xpansion c ontrol l ogic 420 and/or memory controllers 450-1, 450-2, … , 450-M (where M is a positive integer) . The control logic 420 may include a p acket p rocessor 410 configured to process incoming memory packets 414 and outgoing memory packets 412, a m etadata c ache 422, a c ache c ontroller 424, a TLB 426, and /or an MMU 428, which together process incoming and /or outgoing memory packets, maintain translation metadata, and /or coordinate high bandwidth remote memory access. The control logic 420 may be implemented in hardware, firmware, software, or a combination thereof. I n memory p rocessor s / a ccelerators 440 may include or host a CPU/ASIC 442, a r educe o peration 444, an a ggregation u nit 446, and /or c ompression (unit) 448, enabling, for example, SHARP style aggregation/reduction, content compression, and /or other offloads within tier 2. Control/ s pecial commands ( CMD ) 401 and/or request and data 402 can be communicated between the packet processor 410 and the memory expansion control logic 420. The cache controller 424 may send memory request(s) 403 to the memory controllers and receive commends (CMD) and data 404-1, 404-2, … , 404-M via the memory controllers 450-1, 450-2, … , 450-M attached to m emory e xpansion DRAM/HBM a rray 460 in the expansion module.

FIG. 4 illustrates a detailed view of the tier 2 memory expansion, which includes multiple memory controllers 450-1, 450-2, … , 450-M driving the DRAM or HBM arrays. The p acket p rocessor 410 can manage incoming and outgoing memory packets from/to the high BW interconnect 490 . In some implementations , an NVLink controller (e.g., NVLink controllers 351, 352) may serve as the control path for GPUs connected through the NVLink based multi tier memory expansion. In other implementations, this controller may be replaced with a CXL controller, a UALink controller, or a PCIe controller depending on the type of interconnection network being used. In some implementations , the c ache c ontroller 424 may perform caching and /or address translation operations based on the policies employed by the memory system. In some implementations, both the cache controller 424 and the memory controllers 450-1, 450-2, … , 450-M may be integrated directly into the base die of the HBM, allowing memory management operations to occur closer to the physical memory arrays.

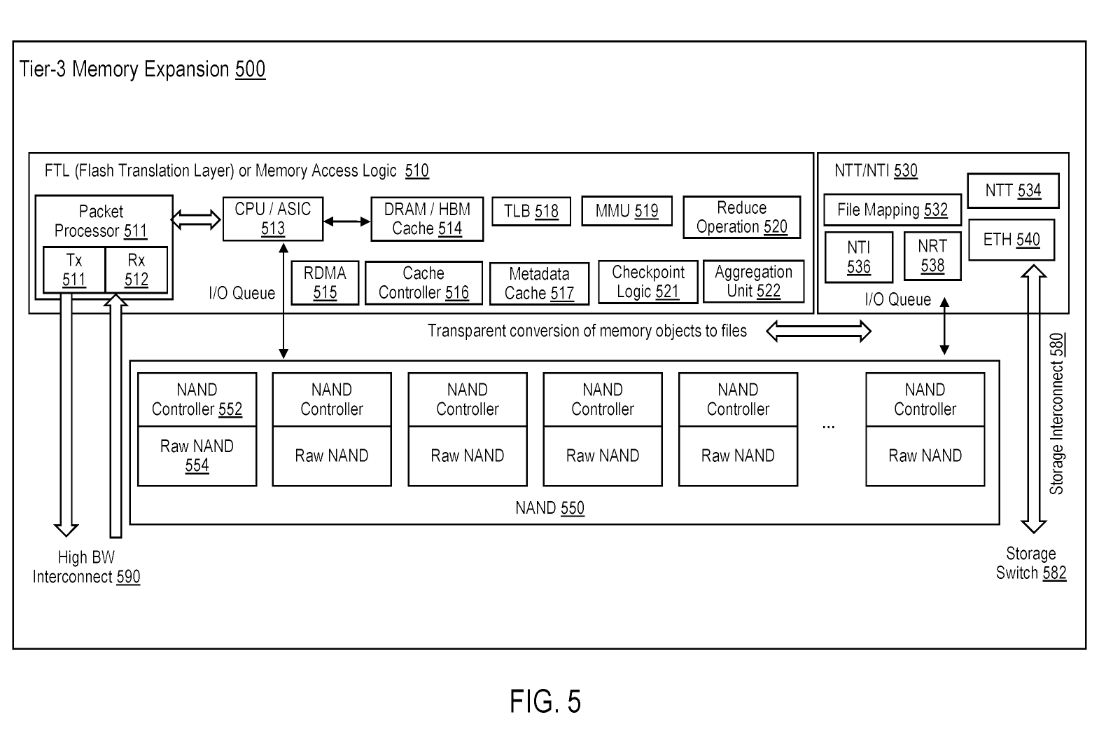

FIG. 5 is a diagram of a tier-3 memory expansion 500 , according to an example implementation of the present disclosure. The t ier 3 m emory e xpansion 500 may integrate or include NAND devices 550 behind one or more NAND c ontrollers 552, each driving arrays of r aw NAND 554 . The tier-3 memory expansion 500 may attach or connect to GPU nodes (e.g., GPU nodes 312 in FIG. 3A) through a h igh BW i nterconnect 590 (e.g., interconnect switches/controllers 351, 352 in FIG. 3A) . The expansion 500 may incorporate or include an FTL (Flash Translation Layer) and/ or m emory a ccess l ogic 510 , and NTT (N VMe over TCP Target ) /NTI ( NVMe over TCP Initiator ) 530 . The FTL/logic 510 may incorporate, include or coordinate a p acket p rocessor 511 configured to process outgoing memory packets Tx 511 and incoming memory packets Rx 512, CPU/ASIC 513, DRAM/HBM cache 514, RDMA 515 , a c ache c ontroller 516, a m etadata c ache 517, a TLB 518, an MMU 519, r educe o peration 520, an a ggregation u nit 522, and/or c heckpoint l ogic 521 . The FTL/logic 510 may be implemented in hardware, firmware, software, or a combination thereof. The NTT/NTI 530 may incorporate, include or coordinate file mapping 532, NTT 534, NTI 536, NRT (NVMe over RDMA Target) 538, and/or ETH 540 (e.g., Ethernet-based interconnect controller). The NTT/NTI 530 may be implemented in hardware, firmware, software, or a combination thereof. The NTT/NTI 530 may communicate with the NAND devices 550 using I/O queue. The r educe o peration 520, a ggregation u nit 522, and c heckpoint l ogic 521 may perform data movement and persistence tasks. The s torage i nterconnect 580 with the s torage s witch 582 may provide an optional path to a separate storage network. The NTT/NTI 530 can perform transparent conversion of load/store memory objects to blocks or objects for file system and storage system access.

In some implementations, the tier-3 memory expansion 500 may be an NVMe memory expansion that uses raw NAND devices, such as CXL.H SSDs (e.g., heterogeneous CXL devices) or NVMe SSDs , connected to the accelerator nodes GPU nodes (e.g., GPU nodes 312 in FIG. 3A) through components such as an NVSwitch, a CXL switch, a UALink switch, a UCIe controller , or the like . The tier 3 memory expansion 500 may include the optional connection to the separate storage interconnect 580 . In some implementations, t he raw NAND devices 550 may be attached to a controller and /or an accelerator in a headless configuration (e.g., without host processors or operating systems) , with the option to include an embedded CPU for additional functionality. This tier-3 memory layer may store cold data or serve as a persistent memory tier. In some implementations, the tier 3 memory layer may further include an extension that supports transparent conversion of stored data into block or object formats that can be accessed by existing file systems or storage systems.

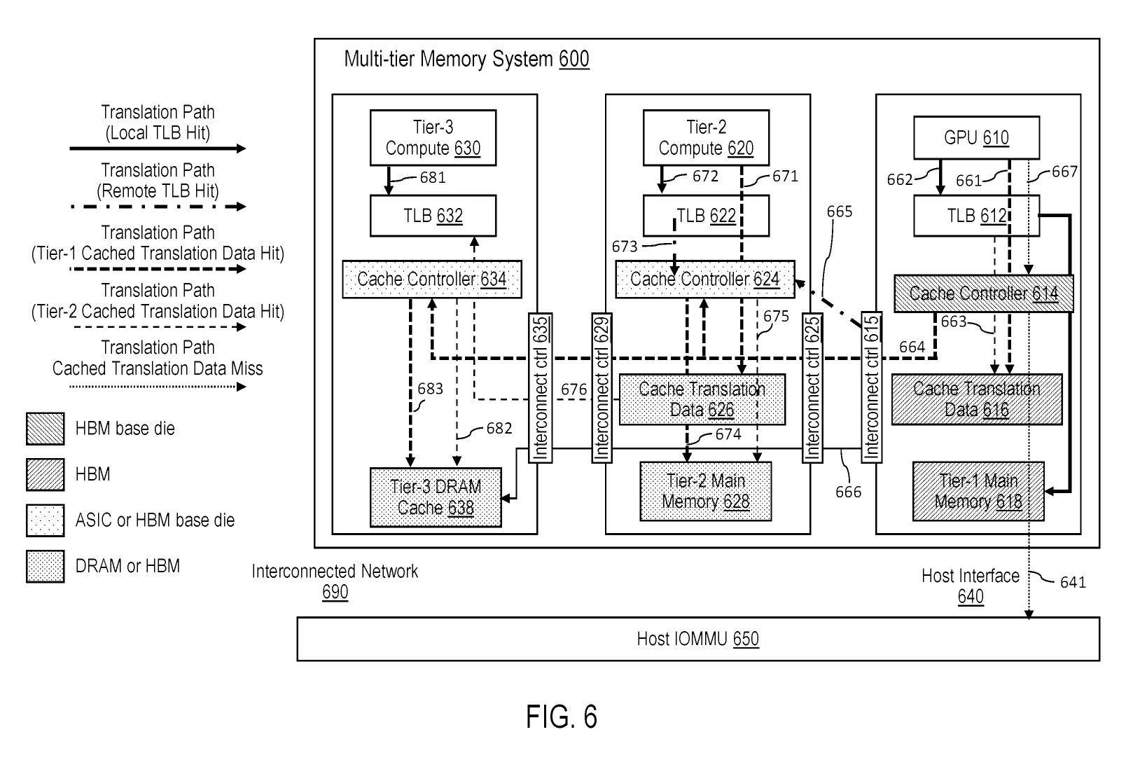

FIG. 6 is a diagram of a multi-tier memory system 600 performing address translation , according to an example implementation of the present disclosure. FIG. 6 illustrates address translation and access paths across tiers under a unified virtual address system operating over an i nterconnected n etwork 690 (e.g., interconnect switch/controller 351, 352) . The tier-1 layer of the memory system 600 may include one or more GPU s 610 , TLB 612, a c ache c ontroller 614, i nterconnect control 615, and /or a t ier 1 main memory 618 . The tier-2 layer of the memory system 600 may include one or more tier-2 computes 620, TLB 6 22, a c ache c ontroller 624, i nterconnect control 625, i nterconnect control 629 , and /or a t ier 2 main memory 628 . The tier-3 layer of the memory system 600 may include one or more tier-3 computes 630, TLB 6 32, a c ache c ontroller 634, i nterconnect control 635, and /or a t ier 3 DRAM c ache 638 . The memory system 600 may be communicated with an IOMMU 650 of the host computer through a host interface 640 (e.g., PCIe).

FIG. 6 illustrates address translation in a multi tier memory system that uses both a TLB (Translation Lookaside Buffer) 612, 622, 643 and cached translation data 616, 626, including cached page table entries and their corresponding physical locations. FIG. 6 shows 5 translation scenarios including (1) local TLB hit, (2) remote TLB hit, (3) Tier-1 cached translation data hit, (4) Tier-2 cached translation data hit, and (5) cached translation data miss. In scenario (1) (indicated by the lines 662, 672, 681), a compute node may encounter a local TLB hit within its own memory tier.

In scenario (2) (indicated by the lines 665, 673), a compute node may encounter a remote TLB hit when it accesses translation data stored in another tier. For example, cached translation data can reside locally (e.g., in tier-1) or remotely (e.g., in tier-2 or tier-3). In this case, say the GPU need to access a memory, the GPU first checks if translation data is in tier-1 TLB, finding that the translation data is not in the tier-1 TLB. If tier-3 has the cached translation data, then a remote TLB hit (miss locally, hit remotely) occurs and the system can access the remote TLB in tier 3 instead of performing a page table walk (which takes a lot more time).

In scenario (3) (indicated by the lines 661, 664, 671, 674, 683), the system may find a hit in the tier-1 cached translation data (e.g., cache translation data 616, 626), which allows the hardware to determine the correct page table location in the remote tier without consulting the IOMMU 650. This scenario (3) can occur when all TLBs miss in which case the system can perform a page walk that performs multiple reads to DRAM (all costly). In some implementations, the compute core (CPU, GPUs) can also utilize a page walk cache, in which some of these reads are cached (so that the system can skip some of the DRAM accesses). In some implementations, the cached translation data (e.g., cache translation data 616, 626) are stored in SRAM.

In scenario (4) (indicated by the lines 663, 675, 676, 682), the system may find a hit in the tier-2 cached translation data, which allows the hardware to determine the correct page table location in the remote tier without consulting the IOMMU 650. In scenario (5) (indicated by the lines 667,641), the cached translation path may miss, consulting the IOMMU 650 to perform a remote page walk and supply the translation.

In some implementations, a GPU (e.g., GPU 610) may include its own memory management unit, and a cache controller (e.g., cache controller 614) may be placed near the local memory (e.g., tier-1 main memory 618), such as on the base die of the HBM, to assist with remote translations and memory accesses through the fabric controller (e.g., interconnect switch/controller 351, 352). The fabric controller may correspond to an NVLink controller in an NVLink based interconnection network, a CXL controller in a CXL based interconnection network, or the like. The translation layer/system shown in FIG. 6 can allow applications to view the entire multi tier memory system 600 as a single virtual address space, while the hardware can transparently manages data placement, memory protection, internal caching, persistence policies, and/or other memory management operations. The controllers responsible for caching (e.g., cache controller 614, 624, 634) and memory management (e.g., memory expansion control logic 420, memory controller 450-1, …, 450-M, memory access logic 510) may reside on the HBM base die or on an expansion card.

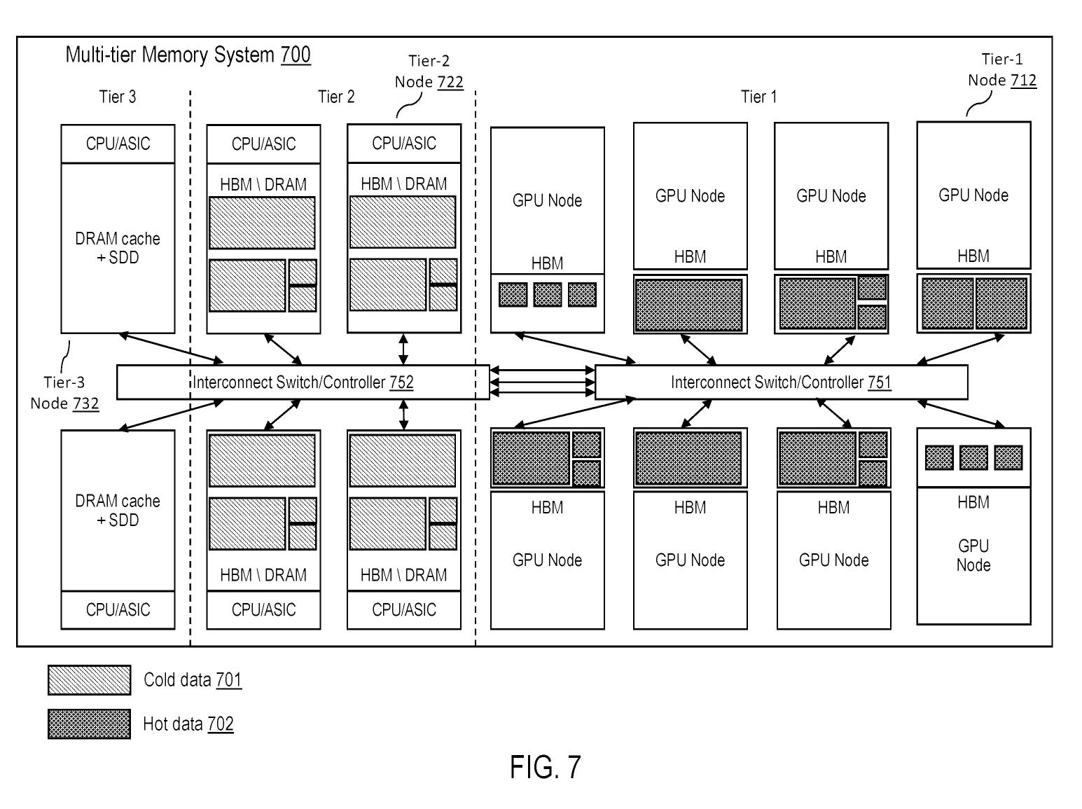

FIG. 7 is a diagram of a multi-tier memory system 700 in which hot and cold application data are distributed across tiers to optimize performance , according to an example implementation of the present disclosure. The memory system 700 may include a set of GPU node(s) in tier 1 (e.g., tier 1 node 712), a set of CPU/ASIC node(s) in tier 2 (e.g., tier 2 node 722), and a set of CPU/ASIC node(s) in tier 3 (e.g., tier 3 node 732). The tier-1 GPU nodes with local HBM may connect, via interconnect switch/controller (e.g., NVSwitch) 751 or 752, to the tier-2 memory including interconnection attached HBM/DRAM managed by the tier-2 CPU/ASIC nodes, and also to the tier-3 memory including DRAM cache and SSD.

FIG. 7 illustrates an example of a caching mechanism in which the models and data of frequently used agents (e.g., hot data 702) within the GPU nodes’ memory, are maintained in the tier 1 memory. At the same time, models and data associated with less frequently used agents (e.g., cold data 701) are placed in the tier 2 memory expansion. Movement of these models between the tiers may occur transparently and adapt to application behaviors. The interconnection network (e.g., NVLink interconnect) can enable this dynamic migration by allowing the memory system 700 to relocate model data based on demand without requiring changes to the running applications.

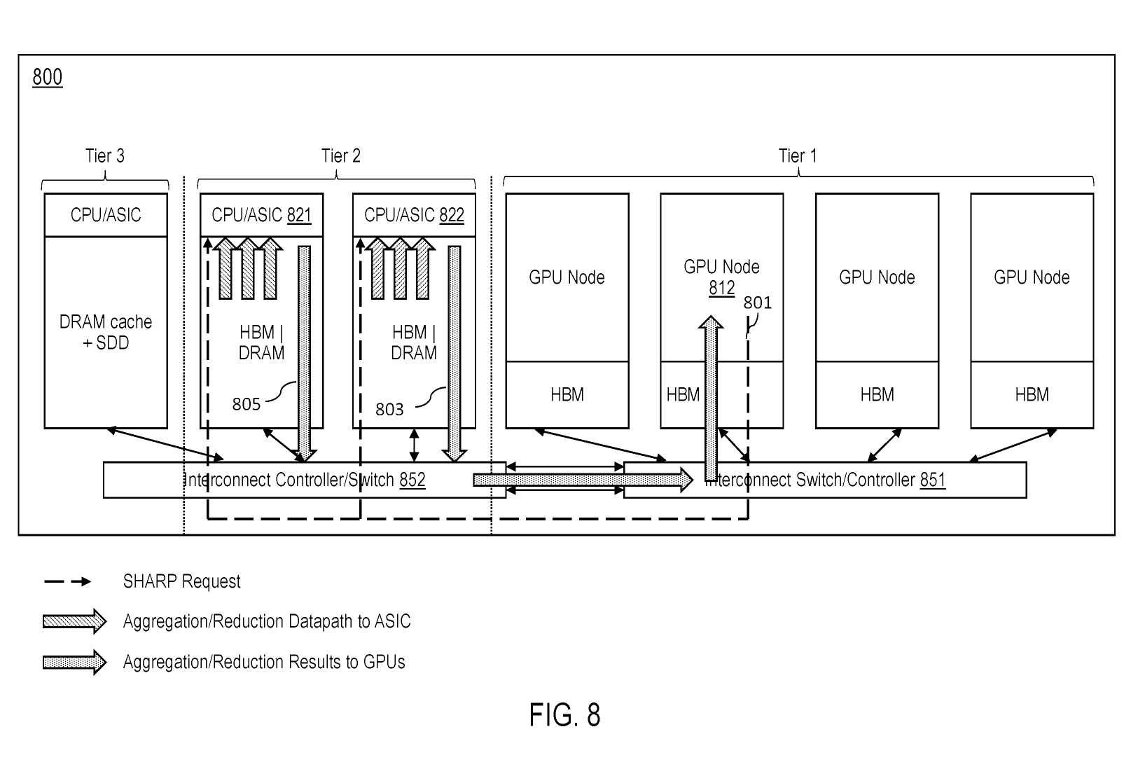

FIG. 8 is a diagram of a multi-tier memory system 800 performing a scalable hierarchical aggregation and reduction protocol (SHARP) , according to an example implementation of the present disclosure. The memory system 800 may perform SHARP style collective communication across tiers through interconnect switch/controllers 851, 852 (e.g., NVSwitch). A plurality of GPU node(s) (e.g., GPU node 812) with local HBM in tier-1 may be connected by the interconnect switch/controllers 851, 852. CPU/ASIC 821 and CPU/ASIC 822 residing at memory expansion nodes in tier-2 can perform aggregation and reduction over an aggregation/reduction data paths 801, 803, 805, returning aggregation/reduction results to GPUs in response to a SHARP Request.

In some implementations, the memory system 800 may provide reduction/aggregation operation s (such as NVIDIA ® SHARP) for data stored in both tier-1 memory and on tier-2 memory. A tier-2 node can operate as an offloaded device for tier-1 data demanding SHARP operations . I n this case , a GPU 812 can send a command 802 to the tier-2 nodes, and the compute units 821, 822 in the tier-2 nodes can perform a reduction and aggregation operation of data connected within the connection network (e.g., NVLink interconnect ) and forward the results 803, 805 of the operation to the requesting GPUs 812. As shown in FIG. 8, multiple tier-2 nodes 821, 822 in the interconnect can perform aggregation and reduction operations in parallel to serve multiple GPU nodes at the same time.

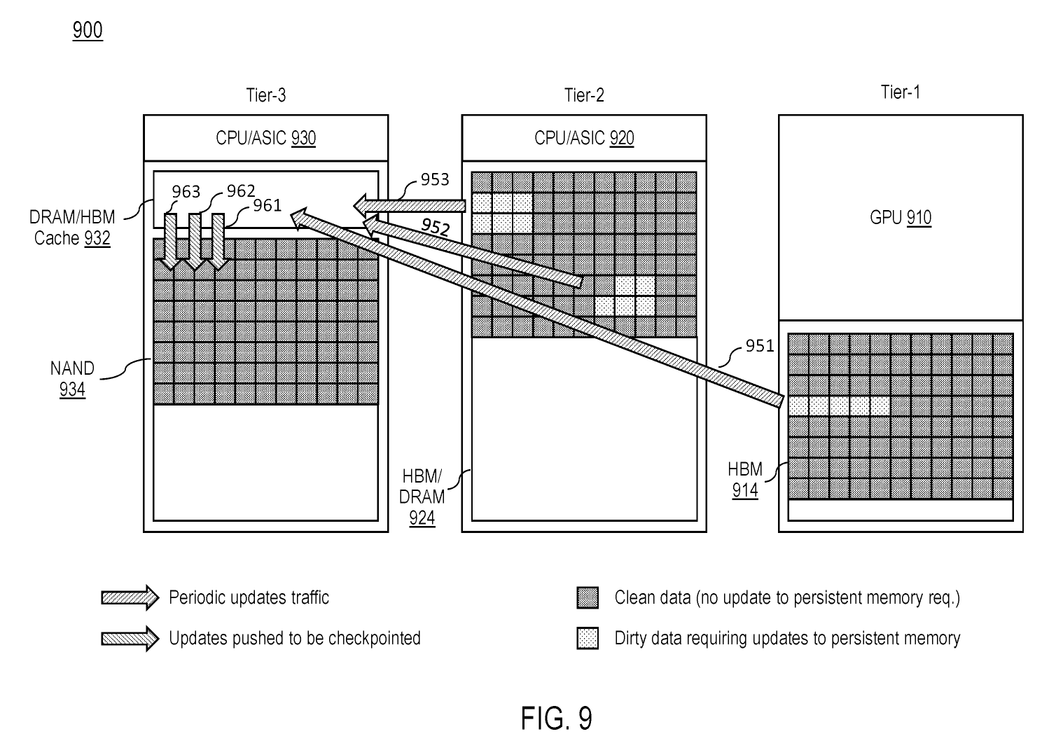

FIG. 9 is a diagram of a multi-tier memory system 900 performing a checkpointing mechanism , according to an example implementation of the present disclosure. In the memory system 900, a GPU 910 with HBM 914 (tier 1) and a tier 2 backend HBM/DRAM 924 managed by CPU/ASIC 920 may cooperate with a tier 3 DRAM/HBM c ache 932 and NAND 934 managed by CPU/ASIC 930 to maintain a durable application state. FIG. 9 illustrates an example checkpointing mechanism in which the DRAM /HBM cache 932 serves as a staging area for updates (e.g., dirty data 951, 952, 953 requiring updates) before the updates are periodically written to the persistent memory in the tier 3 RAW NAND (e.g., data 961, 962, 963 corresponding to the data 951, 952, 953, respectively, and being written to the NAND 934) . In some implementations, the system 900 may support both an update based persistency model and a log based persistency model. As shown in FIG. 9, a persistent memory subsystem (e.g., memory access logic 510 or checkpoint logic 521) can track writes that occur in volatile memory (e.g., HBM/DRAM 924, HBM 914) and temporarily store these updated values in the DRAM or HBM cache 932. When the tier 3 memory receives a checkpoint command, or when a timer triggers a checkpoint interval, the updates stored in the DRAM cache (e.g., data 961, 962, 963 ) may be committed to the persistent NAND array 934. This approach can support different forms of persistent memory management. In a checkpoint based system (e.g., update based persistency model), all modified data may be captured during each checkpoint and written to tier 3. In a log based system, only the changes to the data may be captured in a log structure, and these logs may be written to the persistent memory so that the GPU can later replay the updates and recover its execution state from the most recent checkpoint.

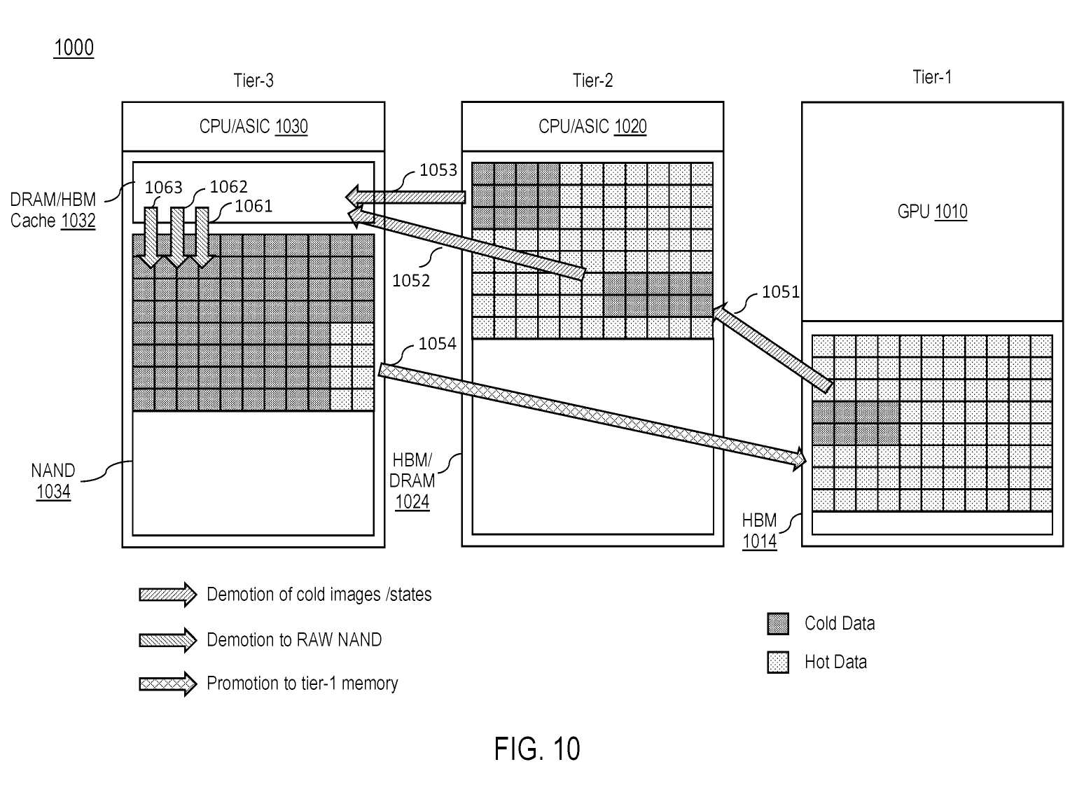

FIG. 10 is a diagram of a multi-tier memory system 1000 performing a quick start and resume mechanism , according to an example implementation of the present disclosure. In the memory system 1000, a GPU 1010 with local HBM 1014 and a tier 2 backend HBM/DRAM 1024 managed by CPU/ASIC 1020 may coordinate with tier 3 resources, e.g., DRAM/HBM Cache 1032 and NAND 1034 managed by CPU/ASIC 1030, to migrate execution images and states among tiers. FIG. 10 illustrates a quick start mechanism for containers, virtual machines, and FaaS in which execution states and images are gradually demoted across memory tiers. In this scenario, when a user image is paused due to a time sharing policy and may need be removed from the accelerator, the system need not swap the image and its state to a NAND flash storage device. Instead, the image and its associated execution state may be migrated to the tier-3 memory (e.g., migration or demotion 1051, 1052, 1053) and optionally encrypted within the tier 3 memory. These images continue to reside within the address space managed by the hypervisor or container management software. In addition, any data used by the system that is evicted to this slower tier 3 NAND can be initially stored in the DRAM cache 1032 of the tier 3 device, which can act as a victim cache for state that is considered cold , and then can be moved to the NAND 1034 (e.g., demotion 1061, 1062, 1063 to Raw NAND corresponding to demotion 1051, 1052, 1053, respectively) . The term “victim cache” may refer to an auxiliary cache that stores recently evicted cache lines from a higher level cache so they can be quickly recovered if they are needed again. In some implementations, images paused due to time sharing can be encrypted and retained in tier 3 to avoid slower storage paths, and promoted back into tier 1 (e.g., promotion 1054) as demand arises to reduce cold start delays.

In some implementations, r esuming an image from tier 3 memory may incur significantly lower latency than restoring it from a conventional storage. For example, t he system 1000 may simply move the execution state back to the accelerator’s compute unit. This may include restoring instructions, program counters, instruction pointers, and /or any relevant cache state to their corresponding destinations, allowing the accelerator (e.g., GPU 1010) to resume execution promptly, as shown in FIG. 10. A similar mechanism may be applied to services operating under a FaaS model. By keeping function images and state materialized within the tier 3 memory (e.g., DRAM/HBM cache 1032) rather than loading them from disk, the system can start and stop functions quickly, avoiding cold start delays and /or enabling rapid, on demand execution.

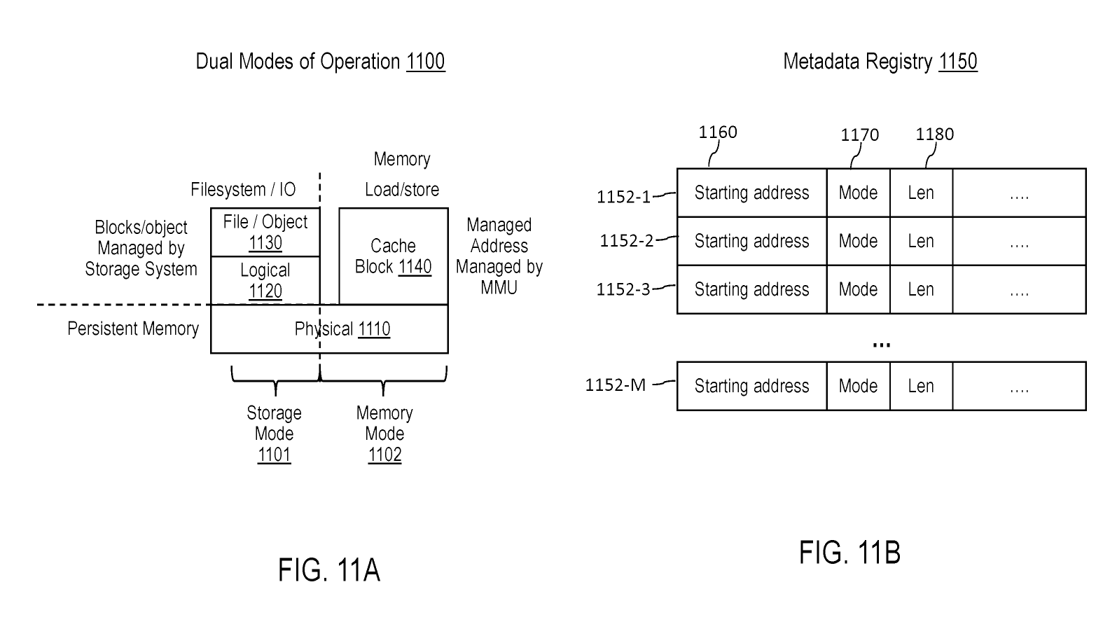

FIGS. 11A and 11B are diagram s of a multi-tier memory system performing dual-mode operations , according to an example implementation of the present disclosure. FIG. 11A depicts dual mode operation 1100 for data in tier 3 persistent memory (e.g., physical memory 1110) , where blocks can operate in a m emory m ode 1102 or in a s torage m ode 1101 . In the memory mode 1102, the data may be loaded or stored in a cache block 1140 under a ddress es m anaged by MMU by memory load/store operations. I n the s torage m ode 1101 , the data may be read or written as files/objects 1130 under logical addresses 1120 by a f ile system and / or an IO stack. FIG. 11B illustrates a metadata registry 1150 (e.g., a metadata structure associated with the dual mode operation 1100). The metadata registry 1150 may have a plurality of entries 1152 1, 11522, 11523, …, 1152 M (where M is a positive integer) representing corresponding data blocks. Each entry may have fields of a starting address 1160 indicating the starting address of the corresponding block, a mode 1170 indicating whether the corresponding block is in the memory mode or in the storage mode, a length 1180 indicating a length of the corresponding block, and/or additional fields (optional).

FIGS. 11A and 11B illustrate an abstraction of two modes of operation (e.g., storage mode 1101 and memory mode 1102) for data stored in the tier 3 memory , and an example metadata registry 1150 that tracks the status of data blocks. Using this approach, the memory system can enable full integration between the memory based data store and the storage based data store without requiring any data movement within tier 3 memory or between tier 3 memory and the rest of the storage system. Because tier 3 memory is nonvolatile and retains all stored data, this approach can satisfy the persistence requirements of a storage subsystem. As a result, data that resides in physical memory (e.g., physical memory 1110) can be transitioned into block or object form (e.g., file/object 1130) for use by the storage system in a transparent manner. To support this capability, some implementations may include a separate metadata registry (e.g., metadata registry 1150) that tracks each block of data and records whether it is operating in memory mode or storage mode (e.g., mode field 1170) . At any given moment, data stored in tier 3 memory may operate in one of these two modes. When operating in memory mode, the data is accessible only through load and store semantics and may be managed by internal address translation structures such as the TLB and memory management unit (e.g., memory access logic 510) . When operating in storage mode, the data is accessible to GPUs, accelerators, hosts, and /or other storage devices through input and output commands.

In some implementations, t he metadata registry 1150 may also maintain a file mapping component that tracks the metadata required to present tier 3 data as blocks or objects to a file system. In some implementations , the hardware may interface with existing file input and output commands, with extensions that support conversion of data between physical memory format (e.g., format for physical memory 1110) and block or object format (e.g., format for file/object 1130) . When such a conversion command is received, the metadata registry 1150 may update the mode of operation (e.g., mode 1170) for the associated data blocks and transitions them between memory mode and storage mode accordingly.

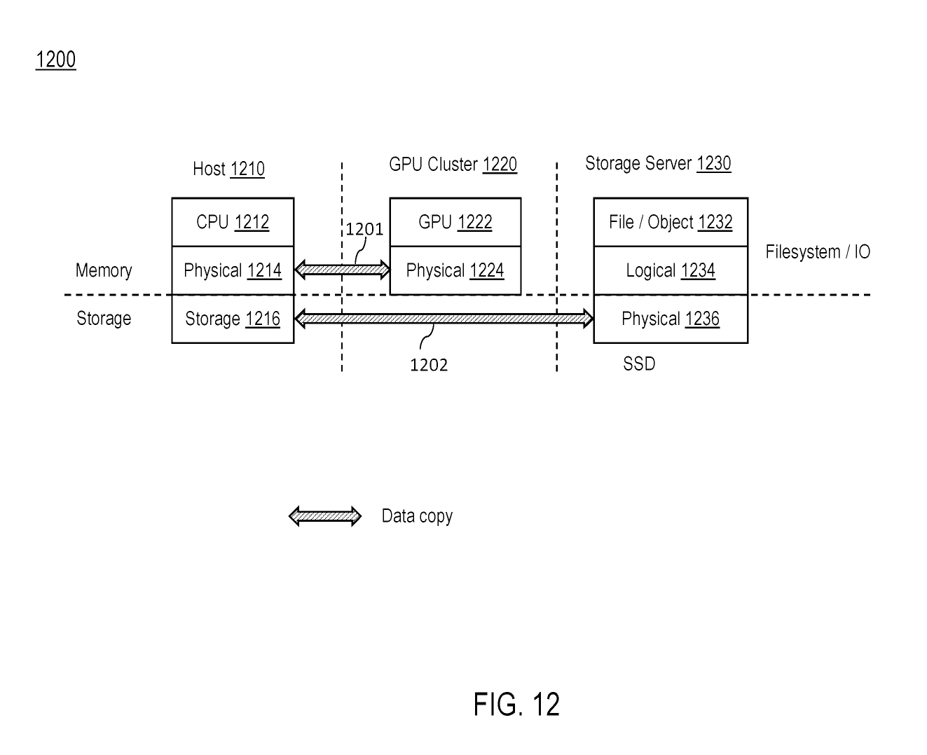

FIG. 12 is a diagram 1200 of data transfer between storages (e.g., storage server or SSD 1230 including files/objects 1232, logical memory 1234, and physical storage 1236) and a host computer (e.g., host 1210 including CPU 1212, physical memory 1214, and storage 1216) , according to an example implementation of the present disclosure. FIG. 12 depicts typical operations in accelerator/GPU-based storage access (as baseline) in which the host CPU 1212 can perform data transfer/copy 1201 between the host and accelerators/GPUs (e.g., GPU 1222), or the host CPU 1212 can perform data transfer/copy 1202 between blocks and objects stored in the storage cluster (e.g., storage server 1230) and the host. As shown in a typical system, storage access may use the host CPU to manage data movement between the storage cluster, where blocks and objects reside, and the compute nodes that include CPUs, accelerators, or GPUs. This model may depend on CPU side processing or GPU programmable threads to run the storage software stack and issue the necessary I/O operations.

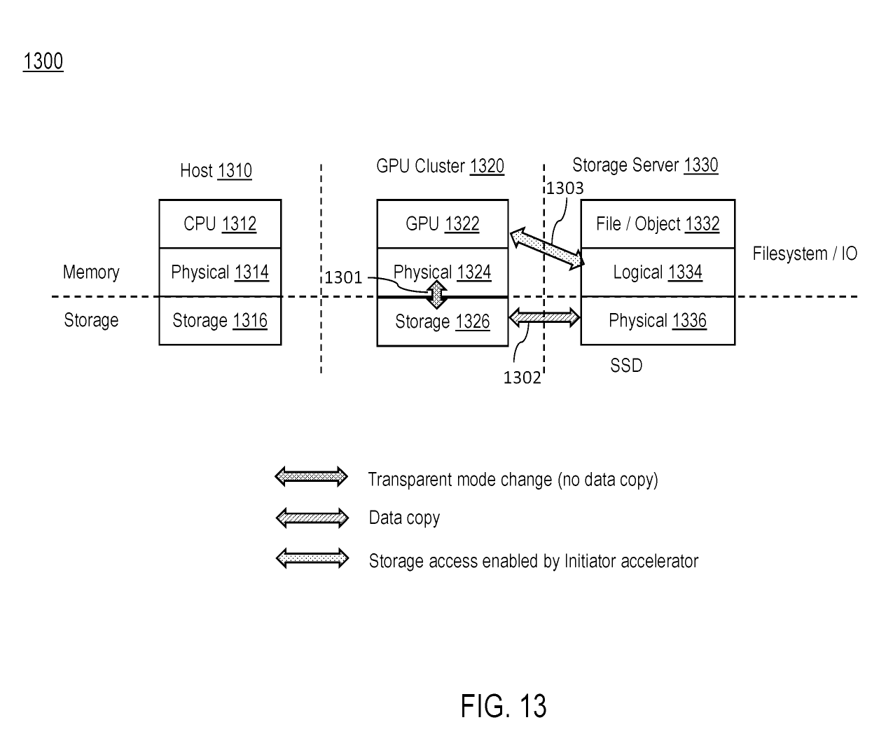

FIG. 13 is a diagram 1300 of data movement and transfer between storages (e.g., storage server or SSD 1330 including files/objects 1332, logical memory 1334, and physical storage 1336) and GPU clusters (e.g., GPU cluster 1320 including GPU 1322, physical memory 1324, and storage 1326) without involvement of a host (e.g., host 1310 including CPU 1312, physical memory 1314, and storage 1316) , according to an example implementation of the present disclosure. For example, the GPU 1322 may initiate access 1303 to the logical memory 1334, followed by a transparent mode change 1301 from the memory mode to the storage mode, and followed by a data transfer/copy between the storage 1326 and the physical storage 1336.

Compared to the data movement and transfer shown in FIG. 12, FIG. 13 shows data movement and transfer using hardware support for an initiator that allows GPUs and accelerators to operate remote SSDs and /or NVMe devices as if they were local. The initiator hardware can handle command processing and I/O management without requiring additional computation by the host CPU or by GPU programmable threads. As a result, accelerators can perform storage operations directly and at lower overhead. The target side accelerator and the transparent dual mode operation of the tier 3 memory (e.g., storage server 1330) further enable direct access between compute nodes (e.g., GPU cluster 1320) and the data stored in the tier 3 memory (e.g., storage server 1330) . In this configuration, other nodes in the compute cluster can treat the tier 3 device as part of the storage system, allowing storage mode data to be accessed directly through I/O commands and memory mode data to be accessed through load and store operations, all under hardware managed control.

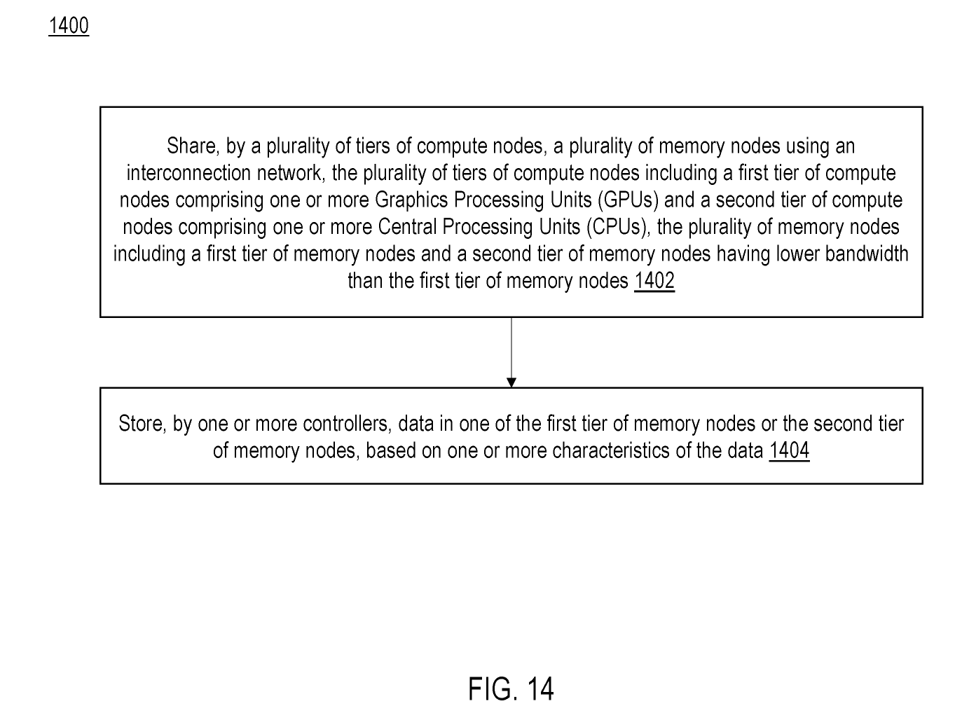

FIG. 14 is a flowchart showing a process 1400 for controlling a plurality of tiers of compute nodes and a plurality of tiers of memory nodes coupled to corresponding tiers of compute nodes , according to an example implementation of the present disclosure. In some implementations, the process 1400 is performed by a device or a system (e.g., the multi-tier system 300, 600, 700, 800, 900, 1000, or 1100 ) including one or more processors or controllers (e.g., interconnect switch/controller 351, 352, 751, 752, 851, 852, memory controller 364-1, 450-1, 450-2, … , 450-M, 552, packet processor 410, 511, control logic 420, memory access logic 510, cache controller 424, 516, 614, 624, 634, etc. ) and one or more memories (e.g., HBM, DRAM, DRAM/HBM array, SSD, NAND, cache memory 517, DRAM/HBM cache 932, 1032 ). In some implementations, the process 1400 includes more, fewer, or different steps than shown in FIG. 14.

In some implementations, a plurality of tiers of compute nodes (e.g., tier-1 compute nodes (or GPU) 312, 361-1, 610, 712, 812, 910, 1010, tier-2 compute nodes (or CPU/ASIC) 322, 380, 442, 513, 620, 722, 821, 822, 920, 1020, tier-3 compute nodes (CPU/ASIC) 332, 630, 732, 930, 1030 ) may include a first tier of compute nodes including one or more GPUs (e.g., tier-1 compute nodes 312, 610, 712, 812, 910, 1010) and a second tier of compute nodes including one or more CPUs (e.g., tier-2 compute nodes 322, 440, 620, 722, 822, 920, and/or tier-3 compute nodes 332, 513, 630, 732, 930) . A plurality of memory nodes (e.g., HBM, DRAM, DRAM/HBM array, SDD, NAND ) may include a first tier of memory nodes (e.g., HBM in tier-1) and a second tier of memory nodes (e.g., HBM/DRAM in tier-2) having lower bandwidth than the first tier of memory nodes.

In some implementations, in step 1402, the one or more controllers may shar e the plurality of memory nodes (e.g., the first tier of memory nodes or the second tier of memory nodes) using an interconnection network (e.g., interconnect switch/controller 351, 352, 751, 752, 851, 852).

In some implementations, in step 1404, the one or more controllers may store data in one of the first tier of memory nodes or the second tier of memory nodes, based on one or more characteristics of the data . In some implementations, the one or more characteristics may include at least one of how frequently data is used (e.g., store more frequently used data in tier-1 memory) or patterns observed in a behavior of an application (e.g., a user interaction that typically precedes the activation of a specific agent ) .

In some implementations, the first tier of memory nodes may include high bandwidth memory (HBM), and the second tier of memory nodes may include dynamic random access memory (DRAM). In some implementations, the plurality of tiers of memory nodes may be shared by the plurality of tiers of compute nodes using remote direct memory access (RDMA).

In some implementations, the plurality of tiers of memory nodes may further include a third tier of memory nodes including non-volatile memory which has lower bandwidth than the second tier of memory nodes. The one or more controllers may be configured to store, in the third tier of memory nodes, first data that are not actively used by the plurality of tiers of compute nodes.

In some implementations, the one or more controllers may be configured to determine a frequency of using second data stored in one of the first tier of memory nodes, the second tier of memory nodes, or the third tier of memory nodes. The one or more controllers may be configured to move, based on the frequency of using the second data, the second data to a different tier of memory nodes.

In some implementations, the one or more controllers may be configured to receive third data and fourth data that relate to one or more machine learning (ML) models. The one or more controllers may be configured to predict model execution patterns of the one or more ML models. The one or more controllers may be configured to determine, based on the predicted model execution patterns, that the fourth data is less frequently used by the plurality of tiers of compute nodes than the third data. The one or more controllers may be configured to store the third data and the fourth data in the first tier of memory nodes and the second tier of memory nodes, respectively. In some implementations, the third data and the fourth data may include model parameters of the one or more ML models. The third data and the fourth data may be stored in key-value (KV) caches allocated in the first tier of memory nodes and the second tier of memory nodes, respectively.

In some implementations, circuitry may control a plurality of tiers of compute nodes (e.g., tier-1 compute nodes (or GPU) 312, 361-1, 610, 712, 812, 910, 1010, tier-2 compute nodes (or CPU/ASIC) 322, 380, 442, 513, 620, 722, 821, 822, 920, 1020, tier-3 compute nodes (CPU/ASIC) 332, 630, 732, 930, 1030 ) and a plurality of tiers of memory nodes ( e.g., HBM, DRAM, DRAM/HBM array, SDD, NAND ) coupled to corresponding tiers of compute nodes. The plurality of tiers of compute nodes may include a first tier of compute nodes including one or more Graphics Processing Units (GPUs) (e.g., tier-1 compute nodes 312, 610, 712, 812, 910, 1010) and a second tier of compute nodes including one or more Central Processing Units (CPUs) (e.g., tier-2 compute nodes 322, 440, 620, 722, 822, 920, and/or tier-3 compute nodes 332, 513, 630, 732, 930) . The plurality of memory nodes may include a first tier of memory nodes (e.g., HBM in tier-1) and a second tier of memory nodes (e.g., HBM/DRAM in tier-2) having lower bandwidth than the first tier of memory nodes. The circuitry may include one or more controllers (e.g., interconnect switch/controller 351, 352, 751, 752, 851, 852, memory controller 364-1, 450-1, 450-2, … , 450-M, 552, packet processor 410, 511, control logic 420, memory access logic 510, cache controller 424, 516, 614, 624, 634, etc. ) configured to control the plurality of tiers of compute nodes to share the plurality of memory nodes (e.g., the first tier of memory nodes or the second tier of memory nodes) using an interconnection network (e.g., interconnect switch/controller 351, 352, 751, 752, 851, 852) .

The one or more controllers may be configured to store data in one of the first tier of memory nodes or the second tier of memory nodes, based on one or more characteristics of the data. In some implementations, the one or more characteristics may include at least one of how frequently data is used (e.g., store more frequently used data in tier-1 memory) or patterns observed in a behavior of an application (e.g., a user interaction that typically precedes the activation of a specific agent ) . In some implementations, the first tier of memory nodes may include high bandwidth memory (HBM). The second tier of memory nodes may include dynamic random access memory (DRAM).

In some implementations, the plurality of tiers of memory nodes may further include a third tier of memory nodes including non-volatile memory which has lower bandwidth than the second tier of memory nodes. The one or more controllers may be configured to store, in the third tier of memory nodes, first data that are not actively used by the plurality of tiers of compute nodes. The one or more controllers may be configured to determine a frequency of using second data stored in one of the first tier of memory nodes, the second tier of memory nodes, or the third tier of memory nodes. The one or more controllers may be configured to move, based on the frequency of using the second data, the second data to a different tier of memory nodes.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/-10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

What is claimed is:

1. A system comprising:
a plurality of tiers of compute nodes which include a first tier of compute nodes comprising one or more Graphics Processing Units (GPUs) and a second tier of compute nodes comprising one or more Central Processing Units (CPUs);
a plurality of tiers of memory nodes, coupled to the corresponding tiers of compute nodes and shared by the plurality of tiers of compute nodes using an interconnection network, comprising a first tier of memory nodes and a second tier of memory nodes having lower bandwidth than the first tier of memory nodes; and
one or more controllers configured to store data in one of the first tier of memory nodes or the second tier of memory nodes, based on one or more characteristics of the data.

2. The system according to claim 1, wherein the one or more characteristics include at least one of how frequently data is used or patterns observed in a behavior of an application.

3. The system according to claim 1, wherein
the first tier of memory nodes comprise high bandwidth memory (HBM), and
the second tier of memory nodes comprise dynamic random access memory (DRAM).

4. The system according to claim 1, wherein
the plurality of tiers of memory nodes are shared by the plurality of tiers of compute nodes using remote direct memory access (RDMA).

5. The system according to claim 1, wherein
the plurality of tiers of memory nodes further comprise a third tier of memory nodes comprising non-volatile memory which has lower bandwidth than the second tier of memory nodes, and
the one or more controllers are configured to store, in the third tier of memory nodes, first data that are not actively used by the plurality of tiers of compute nodes.

6. The system according to claim 1, wherein the one or more controllers are configured to:
determine a frequency of using second data stored in one of the first tier of memory nodes, the second tier of memory nodes, or the third tier of memory nodes, and
move, based on the frequency of using the second data, the second data to a different tier of memory nodes.

7. The system according to claim 1, wherein
the one or more controllers are configured to:
receive third data and fourth data that relate to one or more machine learning (ML) models;
predict model execution patterns of the one or more ML models;
determine, based on the predicted model execution patterns, that the fourth data is less frequently used by the plurality of tiers of compute nodes than the third data; and
store the third data and the fourth data in the first tier of memory nodes and the second tier of memory nodes, respectively.

8. The system according to claim 7, wherein
the third data and the fourth data comprise model parameters of the one or more ML models, and
the third data and the fourth data are stored in key-value (KV) caches allocated in the first tier of memory nodes and the second tier of memory nodes, respectively.

9. A method of controlling a plurality of tiers of compute nodes and a plurality of tiers of memory nodes coupled to the corresponding tiers of compute nodes,
the plurality of tiers of compute nodes including a first tier of compute nodes comprising one or more Graphics Processing Units (GPUs) and a second tier of compute nodes comprising one or more Central Processing Units (CPUs),
the plurality of memory nodes including a first tier of memory nodes and a second tier of memory nodes having lower bandwidth than the first tier of memory nodes,
the method comprising:
sharing, by the plurality of tiers of compute nodes, the plurality of memory nodes using an interconnection network; and
storing, by one or more controllers, data in one of the first tier of memory nodes or the second tier of memory nodes, based on one or more characteristics of the data.

10. The method according to claim 9, wherein the one or more characteristics include at least one of how frequently data is used or patterns observed in a behavior of an application.

11. The method according to claim 9, wherein
the first tier of memory nodes comprise high bandwidth memory (HBM), and
the second tier of memory nodes comprise dynamic random access memory (DRAM).

12. The method according to claim 9, wherein sharing the plurality of memory nodes comprises:
sharing, by the plurality of tiers of compute nodes, the plurality of tiers of memory nodes using remote direct memory access (RDMA).

13. The method according to claim 9, wherein
the plurality of tiers of memory nodes further comprises a third tier of memory nodes comprising non-volatile memory which has lower bandwidth than the second tier of memory nodes, and
the method comprises:
storing, in the third tier of memory nodes, first data that are not actively used by the plurality of tiers of compute nodes.

14. The method according to claim 9, further comprising:
determining a frequency of using second data stored in one of the first tier of memory nodes, the second tier of memory nodes, or the third tier of memory nodes, and
moving, based on the frequency of using the second data, the second data to a different tier of memory nodes.

15. The method according to claim 9, further comprising:
receiving third data and fourth data that relate to one or more machine learning (ML) models, and
predicting model execution patterns of the one or more ML models;
determining, based on the predicted model execution patterns, that the fourth data is less frequently used by the plurality of tiers of compute nodes than the third data; and
storing the third data and the fourth data in the first tier of memory nodes and the second tier of memory nodes, respectively.

16. The method according to claim 15, wherein
the third data and the fourth data comprise model parameters of the one or more ML models, and
the method further comprises:
storing the third data and the fourth data in key-value (KV) caches allocated in the first tier of memory nodes and the second tier of memory nodes, respectively.

17. Circuitry for controlling a plurality of tiers of compute nodes and a plurality of tiers of memory nodes coupled to the corresponding tiers of compute nodes,
the plurality of tiers of compute nodes including a first tier of compute nodes comprising one or more Graphics Processing Units (GPUs) and a second tier of compute nodes comprising one or more Central Processing Units (CPUs),
the plurality of memory nodes including a first tier of memory nodes and a second tier of memory nodes having lower bandwidth than the first tier of memory nodes,
the circuitry comprising one or more controllers configured to:
control the plurality of tiers of compute nodes to share the plurality of memory nodes using an interconnection network; and
store data in one of the first tier of memory nodes or the second tier of memory nodes, based on one or more characteristics of the data.

18. The circuitry according to claim 17, wherein the one or more characteristics include at least one of how frequently data is used or patterns observed in a behavior of an application.

19. The circuitry according to claim 17, wherein
the first tier of memory nodes comprise high bandwidth memory (HBM), and
the second tier of memory nodes comprise dynamic random access memory (DRAM).

20. The circuitry according to claim 17, wherein
the plurality of tiers of memory nodes further comprises a third tier of memory nodes comprising non-volatile memory which has lower bandwidth than the second tier of memory nodes, and
the one or more controllers are configured to:
store, in the third tier of memory nodes, first data that are not actively used by the plurality of tiers of compute nodes;
determine a frequency of using second data stored in one of the first tier of memory nodes, the second tier of memory nodes, or the third tier of memory nodes, and
move, based on the frequency of using the second data, the second data to a different tier of memory nodes.
